(19) United States
(12) Patent Application Publication
(10) Pub. No.: US 2026/0008934 A1
(43) Pub. Date: Jan. 8, 2026

(54) COMPOSITION FOR FORMING GAP-FILLING MATERIAL

(71) Applicant: NISSAN CHEMICAL CORPORATION, Tokyo (JP)

(72) Inventors: Takahiro KISHIOKA, Toyama-shi (JP); Shun KUBODERA, Toyama-shi (JP); Satoshi KAMIBAYASHI, Toyama-shi (JP)

(73) Assignee: NISSAN CHEMICAL CORPORATION, Tokyo (JP)

(21) Appl. No.: 18/881,140

(22) PCT Filed: Aug. 28, 2023
(86) PCT No.: PCT/JP2023/030868

§ 371 Date: Jan. 3, 2025

(30) Foreign Application Priority Data
Aug. 29, 2022 (JP) 2022-135724

(51) Int. Cl. C09D 171/00

(52) U.S. Cl. CPC C09D 171/00

(57) ABSTRACT

A composition forming a gap-filling material, contains: at least one of a compound and polymer having structure represented by Formula (1) and carbonyl bond; and solvent.

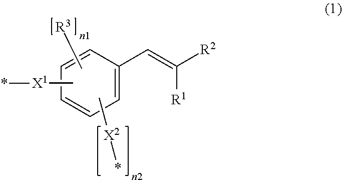

(R¹ and R² each independently represent hydrogen atom, cyano group, phenyl group, alkyl group having 1 to 13 carbon atoms, halogen atom, —COOR¹¹ (R¹¹ represents hydrogen atom or alkyl group having 1 to 4 carbon atoms), or —COO—. When two or more R³'s are present, two or more R³'s may be the same or different. R³ represents methoxy group, alkyl group having 1 to 13 carbon atoms, or halogen atom, and n1 represents an integer of 0 to 4, and n2 represents an integer of 0 or 1, provided that the sum of n1 and n2 is 4 or less. X¹ represents an ether or ester bond. X² represents an ether or ester bond.
(* represents a bond.)

### TECHNICAL FIELD

The present invention relates to a composition for forming a gap-filling material which is preferably used in the producing process of a rewiring layer of a semiconductor device, a cured gap-filling material, a rewiring layer producing method, and a wiring circuit board producing method.

### BACKGROUND ART

Along with demands for smaller size, higher performance, lower cost, and the like for electronic devices, miniaturization and multilayering of wiring circuit boards with semiconductor chips mounted thereon, and high-density mounting of electronic components on wiring circuit boards are advancing together with the miniaturization of semiconductor chips and the inclusion of multiple terminals in semiconductor chips. Together with the inclusion of multiple terminals in semiconductor chips and a decrease in pitch of the terminals, finer wiring is also required for multilayer circuit boards.

Various forms such as a package substrate, a wafer level package (WLP), and a silicon interposer are known with regard to multilayer circuit boards. In general, a semi additive process (SAP) method capable of achieving finer wiring than a subtractive method is applied for a wiring layer of a build-up substrate used for a package substrate, a rewiring layer of a wafer level package, and the like. In the formation of multilayer wiring, a method for building up wiring using a semi additive method and a method for contact-connection of wiring with a via plug using a photo-via method or a damascene method are used (for example, see Patent Literature 1).

### CITATION LIST

### Patent Literature

Patent Literature 1: JP 2011-249483 A

### SUMMARY OF INVENTION

### Technical Problem

A rewiring layer having an insulating layer, wiring formed on a surface of the insulating layer, and a via formed inside the insulating layer is produced through, for example, a dual damascene process. The dual damascene is a technique of simultaneously performing the formation of wiring and the formation of a via by embedding a via hole. Here, a rewiring layer producing process by the dual damascene process will be described with reference to the drawings.

FIGS. 1A to 1K are schematic diagrams for explaining an example of the dual damascene process.

First, a substrate 101 is prepared (FIG. 1A). Next, a photosensitive resin layer 102 is formed on the substrate 101 (FIG. 1B). The photosensitive resin layer 102 used here is a photosensitive resin layer serving as an insulating layer later, and is, for example, a photosensitive polyimide. Next, a through hole is formed in the photosensitive resin layer 102 by photolithography (FIG. 1C). Next, a barrier-seed layer 103 serving as both a barrier layer and a seed layer is formed on a surface of the photosensitive resin layer 102 (FIG. 1D). The barrier-seed layer 103 has, for example, a two-layer structure of a Ti layer as a lower layer and a Cu layer as an upper layer. Next, a plating resist 104 is formed on the barrier-seed layer 103 covering the photosensitive resin layer 102 (FIG. 1E). Next, the plating resist 104 is formed into a desired pattern by photolithography (FIG. 1F). Next, plating is performed on spaces of the plating resist 104 having a desired pattern to form a plating layer 105 (FIG. 1G). The plating layer 105 is formed in an area that serves as a via and an area that serves as wiring later. The plating layer 105 is, for example, a Cu layer. Next, the plating resist 104 is removed by etching. As a result, the plating layer 105 becomes a via 105a formed inside the photosensitive resin layer 102 which is an insulating layer and wiring 105b formed on the surface of the photosensitive resin layer 102 (FIG. 1H). Next, the exposed barrier-seed layer 103 is removed (FIG. 1I). As a result, as shown in FIG. 1I, a rewiring layer having the photosensitive resin layer 102 (insulating layer), the via 105a formed inside the photosensitive resin layer 102, and the wiring 105b formed on the surface of the photosensitive resin layer 102 is formed.

Next, a photosensitive resin layer 106 is formed on the photosensitive resin layer 102 (insulating layer) in which the via 105a and the wiring 105b are formed (FIG. 1J). Next, a through hole is formed in the photosensitive resin layer 106 by photolithography (FIG. 1K). Next, the same steps as those shown in FIGS. 1D to 1I are performed. As a result, it is possible to create a multilayer structure of the rewiring layers.

Here, the metal such as Cu constituting the via 105a and the wiring 105b is likely to migrate to the insulating layer. Therefore, the barrier-seed layer 103 having a function of preventing the migration is formed. However, as shown in FIGS. 1I to 1K, on the upper surface of the photosensitive resin layer 102, the barrier-seed layer 103 is formed only on the lower sides of the via 105a and the wiring 105b, and side surfaces of the via 105a and the wiring 105b occupying a large area among the surfaces of the via 105a and the wiring 105b have no barrier-seed layer 103. Therefore, the migration is not sufficiently prevented.

An object of the present invention is to provide a composition for forming a gap-filling material which can be suitably used for temporary embedding of a through hole in an insulating layer in the production of a rewiring layer, a cured gap-filling material using the composition for forming a gap-filling material, and a wiring circuit board producing method using the composition for forming a gap-filling material.

### Solution to Problem

The inventors have conducted intensive studies to solve the above-described problems. As a result, they have found that the above-described problems can be solved and have completed the present invention having the following gist.

That is, the present invention includes the following.
[1] A composition for forming a gap-filling material, containing: at least one of a compound and a polymer having a structure represented by the following Formula (1) and a carbonyl bond; and a solvent.

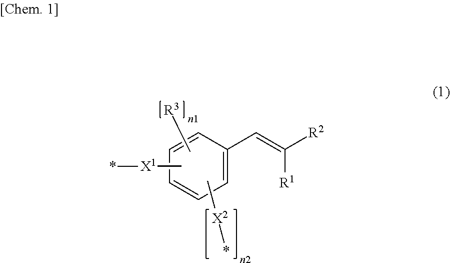

(In Formula (1), R¹ and R² each independently represent a hydrogen atom, a cyano group, a phenyl group, an alkyl group having 1 to 13 carbon atoms, a halogen atom, —COOR¹¹ (R¹¹ represents a hydrogen atom or an alkyl group having 1 to 4 carbon atoms), or —COO—.

R³ represents a methoxy group, an alkyl group having 1 to 13 carbon atoms, or a halogen atom, and when two or more R³'s are present, the two or more R³'s may be the same or different.

n1 represents an integer of 0 to 4, and n2 represents an integer of 0 or 1, provided that the sum of n1 and n2 is 4 or less.
X¹ represents an ether bond or an ester bond.
X² represents an ether bond or an ester bond.
* represents a bond.)
[2] The composition for forming a gap-filling material according to [1], wherein the compound and the polymer have, as a structure having the carbonyl bond, at least one of a structure represented by the following Formula (2) and a structure represented by the following Formula (3).

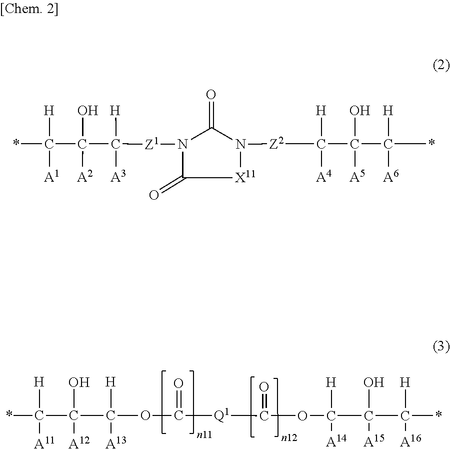

(In Formula (2), X¹¹ represents a group represented by any one of the following Formulas (2-1) to (2-4). Z¹ and Z² each independently represent a single bond or a divalent group represented by the following Formula (2-5) (in Formula (2-5), *3 represents a bond bonded to a nitrogen atom in Formula (2)). A¹, A², A³, A⁴, A⁵, and A⁶ each independently represent a hydrogen atom, a methyl group, or an ethyl group. * represents a bond.

In Formula (3), Q¹ represents a divalent organic group having an aromatic hydrocarbon ring. A¹¹, A¹², A¹³, A¹⁴, A¹⁵, and A¹⁶ each independently represent a hydrogen atom, a methyl group, or an ethyl group. n11 and n12 represent an integer of 0 or 1, provided that at least one of n11 and n12 is 1. * represents a bond.)

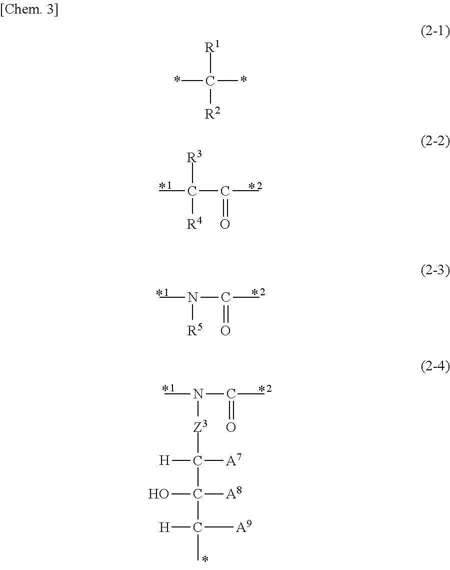

(In Formulas (2-1) to (2-3), R¹ to R⁵ each independently represent a hydrogen atom, an alkyl group having 1 to 10 carbon atoms which may be interrupted with an oxygen atom or a sulfur atom, an alkenyl group having 2 to 10 carbon atoms which may be interrupted with an oxygen atom or a sulfur atom, an alkynyl group having 2 to 10 carbon atoms which may be interrupted with an oxygen atom or a sulfur atom, a benzyl group, or a phenyl group, and the phenyl group may be substituted with at least one monovalent group selected from the group consisting of an alkyl group having 1 to 6 carbon atoms, a halogen atom, an alkoxy group having 1 to 6 carbon atoms, a nitro group, a cyano group, and an alkylthio group having 1 to 6 carbon atoms. R¹ and R² may be bonded to each other to form a ring having 3 to 6 carbon atoms. R³ and R⁴ may be bonded to each other to form a ring having 3 to 6 carbon atoms.

In Formula (2-4), Z³ represents a single bond or a divalent group represented by the following Formula (2-5) (in Formula (2-5), *3 represents a bond bonded to a nitrogen atom in Formula (2-4)). A⁷, A⁸, and A⁹ each independently represent a hydrogen atom, a methyl group, or an ethyl group.
* represents a bond. *1 represents a bond bonded to a carbon atom in Formula (2). *2 represents a bond bonded to a nitrogen atom in Formula (2).)

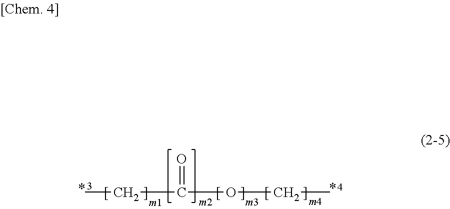

(In Formula (2-5), m1 is an integer of 0 to 4, m2 is 0 or 1, m3 is 0 or 1, and m4 is an integer of 0 to 2, provided that, when m3 is 1, m1 and m2 are not both 0 at the same time. *3 represents a bond bonded to a nitrogen atom in Formula (2) or (2-4). *4 represents a bond bonded to a carbon atom in Formula (2) or (2-4).)
[3] The composition for forming a gap-filling material according to [2], wherein Q is represented by the following Formula (3-1) or (3-2).

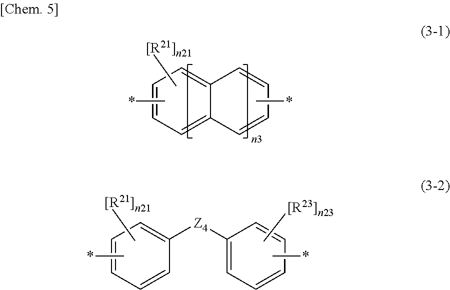

(In Formulas (3-1) and (3-2), R²¹ to R²³ each independently represent a halogen atom, a hydroxy group, an alkyl group having 1 to 6 carbon atoms, an alkenyl group having 2 to 6 carbon atoms, an alkynyl group having 2 to 6 carbon atoms, an alkoxy group having 1 to 6 carbon atoms, an alkenyloxy group having 2 to 6 carbon atoms, an alkynyloxy group having 2 to 6 carbon atoms, an acyl group having 2 to 6 carbon atoms, an aryloxy group having 6 to 12 carbon atoms, an arylcarbonyl group having 7 to 13 carbon atoms, or an aralkyl group having 7 to 13 carbon atoms. * represents a bond.

In Formula (3-1), n3 represents 0 or 1. When n3 is 0, n21 represents an integer of 0 to 4. When n3 is 1, n21 represents an integer of 0 to 6. When two or more R²¹'s are present, the two or more R²¹'s may be the same or different.

In Formula (3-2), Z⁴ represents a single bond, an oxygen atom, a sulfur atom, a carbonyl group, a sulfonyl group, or an alkylene group having 1 to 6 carbon atoms. n22 and n23 each independently represent an integer of 0 to 4. When two or more R²²'s are present, the two or more R²²'s may be the same or different. When two or more R²³'s are present, the two or more R²³'s may be the same or different.)
[4] The composition for forming a gap-filling material according to any one of [1] to [3], wherein R¹ represents a cyano group or —COOR¹¹ (R¹¹ represents a hydrogen atom or an alkyl group having 1 to 4 carbon atoms).
[5] The composition for forming a gap-filling material according to any one of [1] to [4], wherein R² represents a cyano group, —COOR¹¹ (R¹¹ represents a hydrogen atom or an alkyl group having 1 to 4 carbon atoms), or —COO—.
[6] The composition for forming a gap-filling material according to any one of [1] to [5], wherein X¹ represents an ether bond.
[7] The composition for forming a gap-filling material according to any one of [1] to [6], wherein n2 represents 0.
[8] The composition for forming a gap-filling material according to any one of [1] to [7], wherein a crosslinking agent is contained.
[9] The composition for forming a gap-filling material according to any one of [1] to [8], which is used for temporary embedding of a through hole in an insulating layer in production of a rewiring layer.
[10] A cured gap-filling material, which is formed by applying the composition for forming a gap-filling material according to any one of [1] to [9] to a substrate and then baking the composition.
[11] The cured material according to [10], which is removable with a chemical solution.
[12] A rewiring layer producing method including a step of: filling a through hole of an insulating layer with a cured gap-filling material formed from the composition for forming a gap-filling material according to any one of [1] to [9].
[13] The rewiring layer producing method according to [12], further including a step of: removing the cured gap-filling material with a chemical solution after the step of filling the through hole.
[14] A wiring circuit board producing method including a step of: producing a rewiring layer,
wherein the step of producing a rewiring layer includes a step of filling a through hole of an insulating layer with a cured gap-filling material formed from the composition for forming a gap-filling material according to any one of [1] to [9].
[15] The wiring circuit board producing method according to [14], further including a step of: removing the cured gap-filling material with a chemical solution after the step of filling the through hole.

### Advantageous Effects of Invention

According to the present invention, it is possible to provide a composition for forming a gap-filling material which can be suitably used for temporary embedding of a through hole in an insulating layer in the production of a rewiring layer, a cured gap-filling material using the composition for forming a gap-filling material, and a wiring circuit board producing method using the composition for forming a gap-filling material.

### BRIEF DESCRIPTION OF DRAWINGS

FIG. 1A is a schematic diagram for explaining an example of a dual damascene process (part 1).

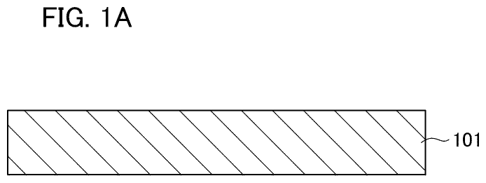

FIG. 1B is a schematic diagram for explaining an example of the dual damascene process (part 2).

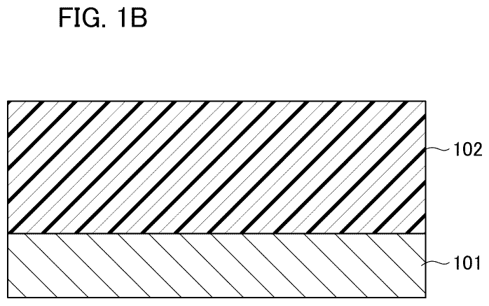

FIG. 1C is a schematic diagram for explaining an example of the dual damascene process (part 3).

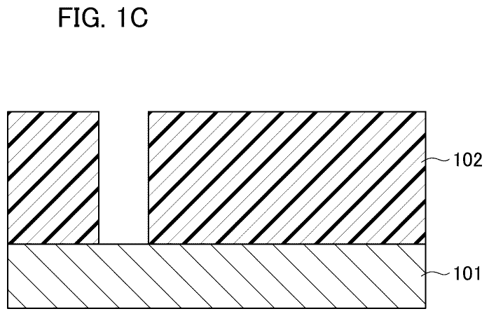

FIG. 1D is a schematic diagram for explaining an example of the dual damascene process (part 4).

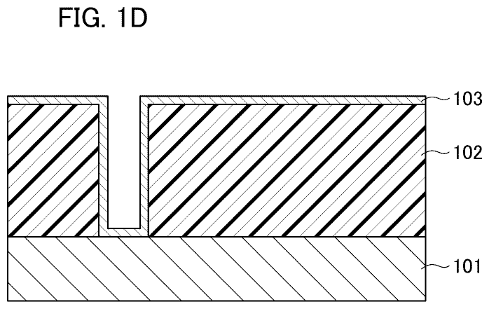

FIG. 1E is a schematic diagram for explaining an example of the dual damascene process (part 5).

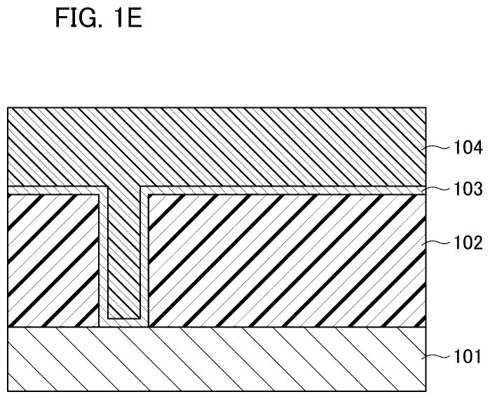

FIG. 1F is a schematic diagram for explaining an example of the dual damascene process (part 6).

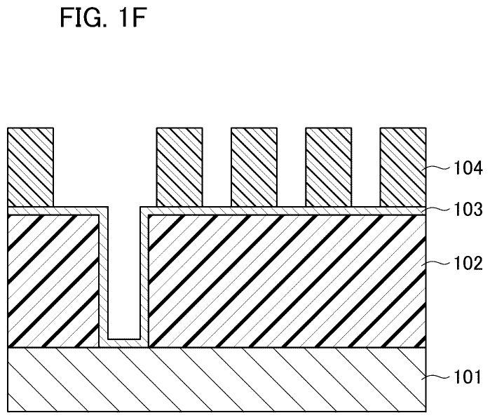

FIG. 1G is a schematic diagram for explaining an example of the dual damascene process (part 7).

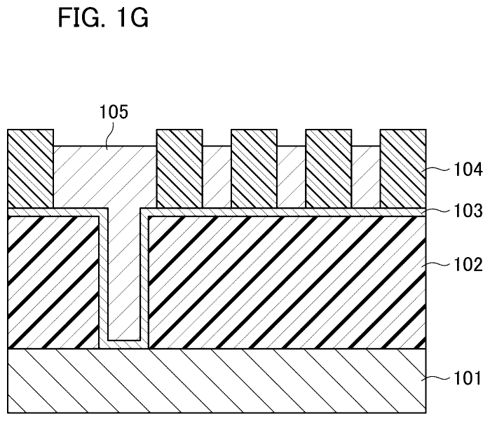

FIG. 1H is a schematic diagram for explaining an example of the dual damascene process (part 8).

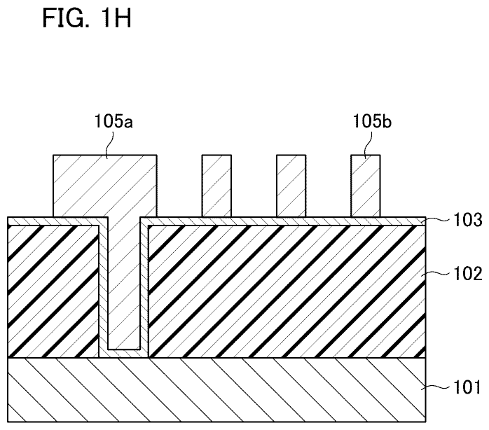

FIG. 1I is a schematic diagram for explaining an example of the dual damascene process (part 9).

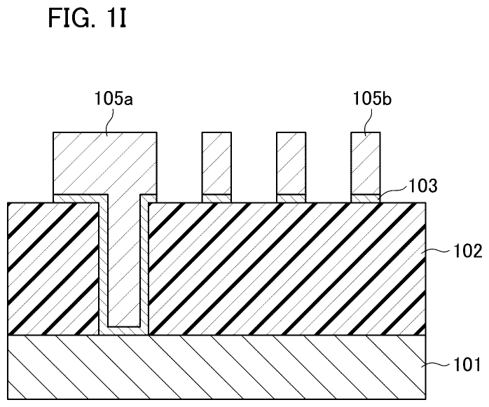

FIG. 1J is a schematic diagram for explaining an example of the dual damascene process (part 10).

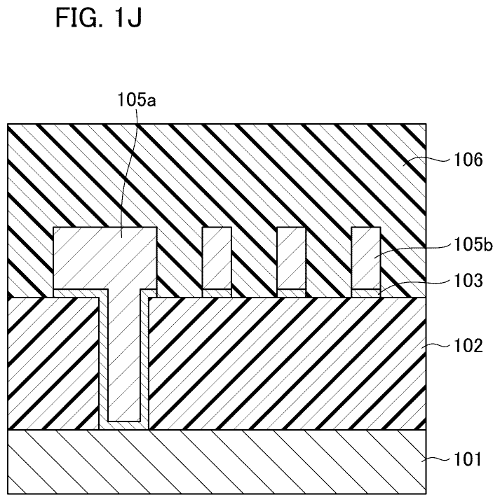

FIG. 1K is a schematic diagram for explaining an example of the dual damascene process (part 11).

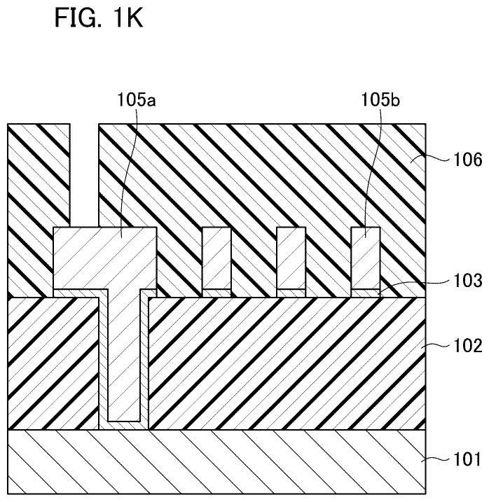

FIG. 2A is a schematic diagram for explaining an embodiment of the present invention (the formation of a rewiring layer using a dual damascene process) (part 1).

FIG. 2B is a schematic diagram for explaining an embodiment of the present invention (the formation of the rewiring layer using the dual damascene process) (part 2).

FIG. 2C is a schematic diagram for explaining an embodiment of the present invention (the formation of the rewiring layer using the dual damascene process) (part 3).

FIG. 2D is a schematic diagram for explaining an embodiment of the present invention (the formation of the rewiring layer using the dual damascene process) (part 4).

FIG. 2E is a schematic diagram for explaining an embodiment of the present invention (the formation of the rewiring layer using the dual damascene process) (part 5).

FIG. 2F is a schematic diagram for explaining an embodiment of the present invention (the formation of the rewiring layer using the dual damascene process) (part 6).

FIG. 2G is a schematic diagram for explaining an embodiment of the present invention (the formation of the rewiring layer using the dual damascene process) (part 7).

FIG. 2H is a schematic diagram for explaining an embodiment of the present invention (the formation of the rewiring layer using the dual damascene process) (part 8).

FIG. 2I FIG. 2I is a schematic diagram for explaining an embodiment of the present invention (the formation of the rewiring layer using the dual damascene process) (part 9).

FIG. 2J is a schematic diagram for explaining an embodiment of the present invention (the formation of the rewiring layer using the dual damascene process) (part 10).

FIG. 2K is a schematic diagram for explaining an embodiment of the present invention (the formation of the rewiring layer using the dual damascene process) (part 11).

FIG. 3 is an SEM photograph in evaluation of embeddability and flatness of Example 1.

FIG. 4 is an SEM photograph in evaluation of embeddability and flatness of Example 2.

FIG. 5 is an SEM photograph in evaluation of embeddability and flatness of Example 3.

FIG. 6 is an SEM photograph in evaluation of embeddability and flatness of Example 4.

FIG. 7 is an SEM photograph in evaluation of embeddability and flatness of Comparative Example 1.

### DESCRIPTION OF EMBODIMENTS

### (Composition for Forming Gap-Filling Material)

A composition for forming a gap-filling material of the present invention contains: at least one of a compound and a polymer having a structure represented by the following Formula (1) and a carbonyl bond; and a solvent.

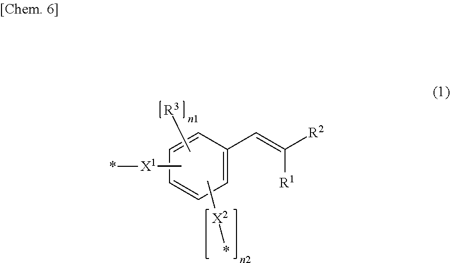

(In Formula (1), R¹ and R² each independently represent a hydrogen atom, a cyano group, a phenyl group, an alkyl group having 1 to 13 carbon atoms, a halogen atom, —COOR¹¹ (R¹¹ represents a hydrogen atom or an alkyl group having 1 to 4 carbon atoms), or —COO—.
R³ represents a methoxy group, an alkyl group having 1 to 13 carbon atoms, or a halogen atom, and when two or more R³'s are present, the two or more R³'s may be the same or different.
n1 represents an integer of 0 to 4, and n2 represents an integer of 0 or 1, provided that the sum of n1 and n2 is 4 or less.
X¹ represents an ether bond or an ester bond.
X² represents an ether bond or an ester bond.
* represents a bond.)

The composition for forming a gap-filling material of the present invention can be suitably used for temporary embedding of a through hole in an insulating layer in the production of a rewiring layer.

In a case where the composition for forming a gap-filling material of the present invention is used for temporary embedding of a through hole in an insulating layer in the production of a rewiring layer, a via and wiring in which a barrier layer is formed not only on a lower surface but also on a side surface can be formed in the rewiring layer. As a result, the migration of metal from the via and the wiring to the insulating layer can be reduced, and a highly reliable rewiring layer can be formed. Preferably, the composition of the present invention can be used as a gap-filling material in a dual damascene process.

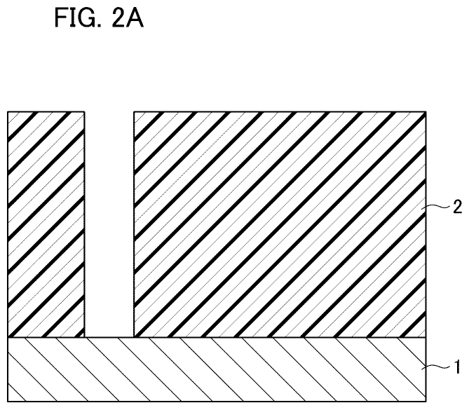

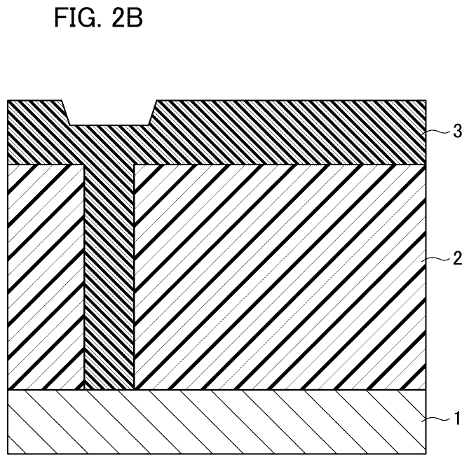

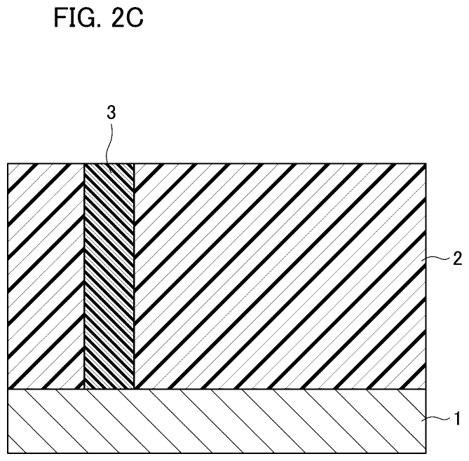

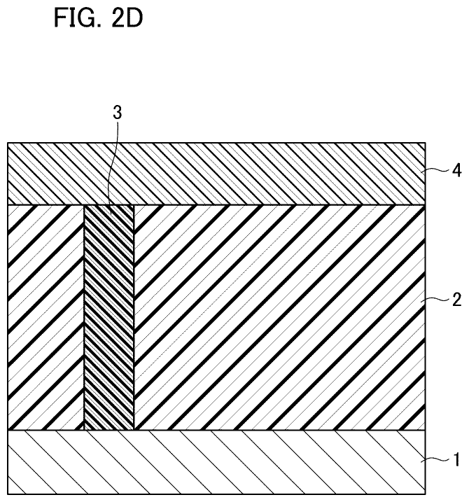

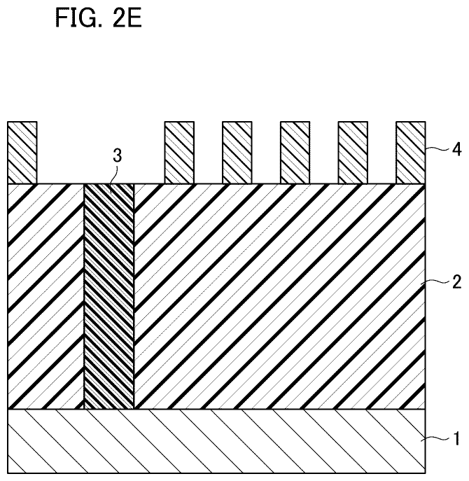

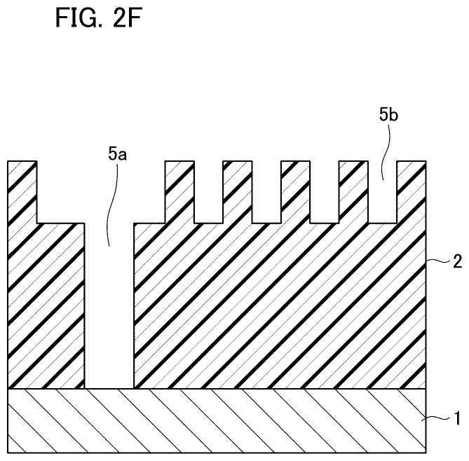

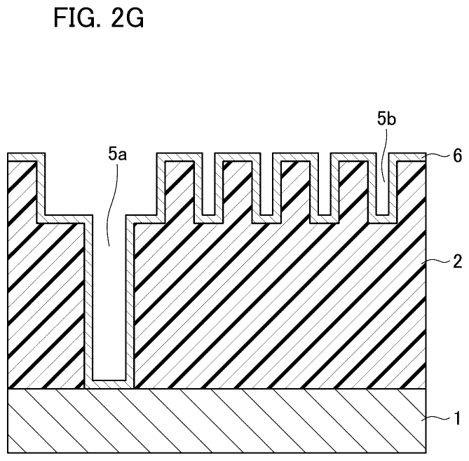

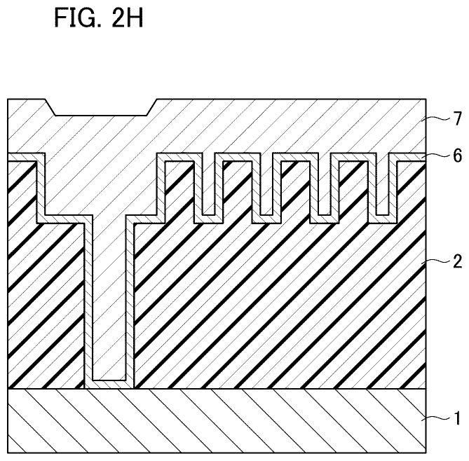

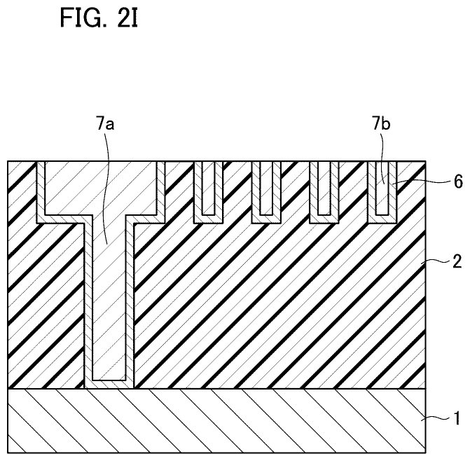

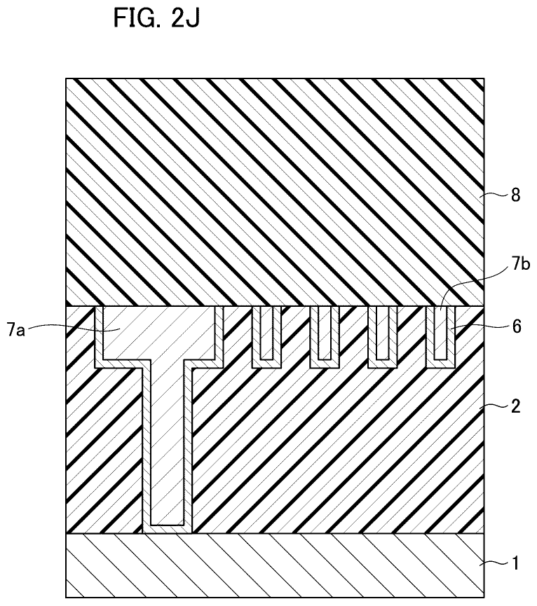

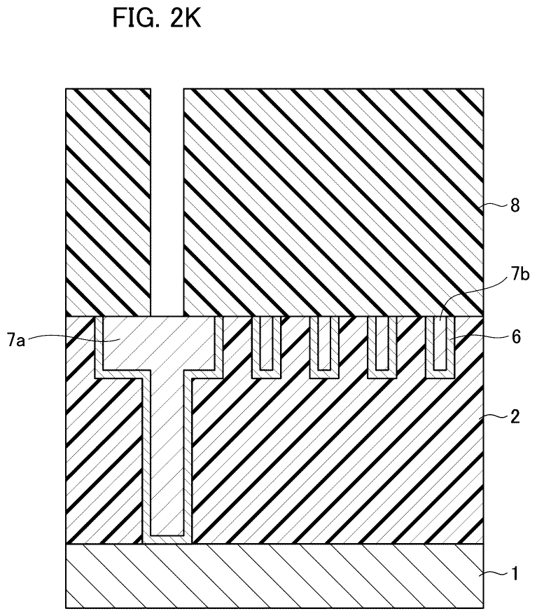

Details thereof will be described later with reference to FIGS. 2A to 2K.

### <Compound and Polymer>

The compound and polymer (hereinafter, may be referred to as “specific compound and polymer”) contained in the composition for forming a gap-filling material has a structure represented by the following Formula (1) and a carbonyl bond.

In the present invention, the difference between the compound and the polymer does not need to be particularly clear. For example, as long as they are substances having a structure represented by Formula (1) and a carbonyl bond, they may have a low molecular weight or a high molecular weight, may be of a single composition, or may have a molecular weight distribution (for example, the polydispersity (weight average molecular weight/number average molecular weight) may be more than 1).

### <<Structure Represented by Formula (1)>>

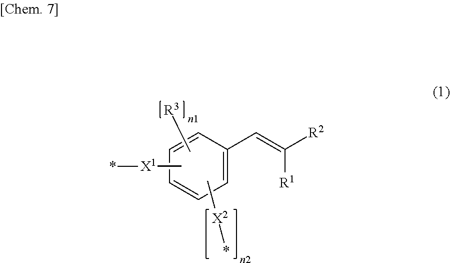

(In Formula (1), R¹ and R² each independently represent a hydrogen atom, a cyano group, a phenyl group, an alkyl group having 1 to 13 carbon atoms, a halogen atom, —COOR¹¹ (R¹¹ represents a hydrogen atom or an alkyl group having 1 to 4 carbon atoms), or —COO—.
R³ represents a methoxy group, an alkyl group having 1 to 13 carbon atoms, or a halogen atom, and when two or more R³′s are present, the two or more R³'s may be the same or different.
n1 represents an integer of 0 to 4, and n2 represents an integer of 0 or 1, provided that the sum of n1 and n2 is 4 or less.
X¹ represents an ether bond or an ester bond.
X² represents an ether bond or an ester bond.
* represents a bond.)

Since the structure represented by Formula (1) has absorption for ultraviolet rays (for example, i-rays (365 nm)), a cured gap-filling material obtained from the composition for forming a gap-filling material has an antireflection function. Therefore, it is possible to prevent patterning failure of a photoresist layer when photolithography is performed by forming the photoresist layer on the cured gap-filling material. That is, the composition for forming a gap-filling material of the present invention can also be said to be a composition for forming an antireflection layer or a composition for forming an ultraviolet antireflection layer.

Examples of the alkyl group having 1 to 13 carbon atoms of R¹ to R³ in Formula (1) include an alkyl group having 1 to 6 carbon atoms.

Examples of the alkyl group having 1 to 6 carbon atoms include methyl group, ethyl group, isopropyl group, n-butyl group, and cyclohexyl group.

Examples of the alkyl group having 1 to 4 carbon atoms of R¹¹ in Formula (1) include methyl group, ethyl group, isopropyl group, and n-butyl group.
X¹ in Formula (1) preferably represents an ether bond.
R¹ in Formula (1) preferably represents a cyano group or —COOR¹¹ (R¹¹ represents a hydrogen atom or an alkyl group having 1 to 4 carbon atoms).
R² in Formula (1) preferably represents a cyano group, —COOR¹¹ (R¹¹ represents a hydrogen atom or an alkyl group having 1 to 4 carbon atoms), or —COO—.
n2 in Formula (1) preferably represents 0.

### <<Carbonyl Bond>>

The specific compound and polymer have a carbonyl bond in addition to the structure represented by Formula (1). In a case where the specific compound and polymer have a carbonyl bond, a cured gap-filling material obtained from the composition for forming a gap-filling material has excellent removability. Therefore, the composition for forming a gap-filling material can be suitably used for temporary embedding of a through hole in an insulating layer in the production of a rewiring layer.

The cured gap-filling material is removed by, for example, wet etching using a basic organic solvent or dry etching.

The carbon atom of the carbonyl bond (—CO—) may be bonded to a carbon atom, an oxygen atom, or a nitrogen atom. Therefore, the carbonyl bond may be a carbonyl bond in an ester group (—COO—), a carbonyl bond in an amide group (—CO—NH—), a carbonyl bond in an isocyanuric acid skeleton, or a carbonyl bond in a hydantoin skeleton.

The amount of the carbonyl bond in the specific compound and polymer is not particularly limited.

The specific compound and polymer preferably have, as a structure having a carbonyl bond, at least one of a structure represented by the following Formula (2) and a structure represented by the following Formula (3).

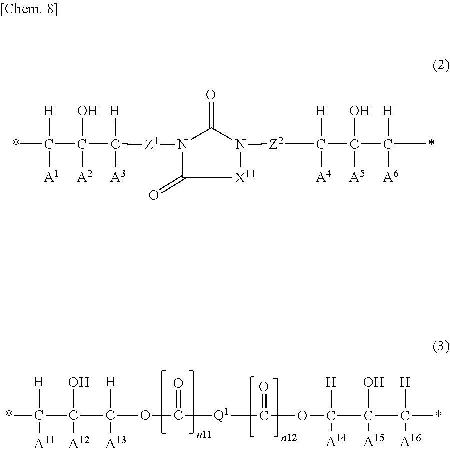

(In Formula (2), X¹¹ represents a group represented by any one of the following Formulas (2-1) to (2-4). Z¹ and Z² each independently represent a single bond or a divalent group represented by the following Formula (2-5) (in Formula (2-5), *3 represents a bond bonded to a nitrogen atom in Formula (2)). A¹, A², A³, A⁴, A⁵, and A⁶ each independently represent a hydrogen atom, a methyl group, or an ethyl group. * represents a bond.

In Formula (3), Q¹ represents a divalent organic group having an aromatic hydrocarbon ring. A¹¹, A¹², A¹³, A¹⁴, A¹⁵, and A¹⁶ each independently represent a hydrogen atom, a methyl group, or an ethyl group. n11 and n12 represent an integer of 0 or 1, provided that at least one of n11 and n12 is 1. * represents a bond.)

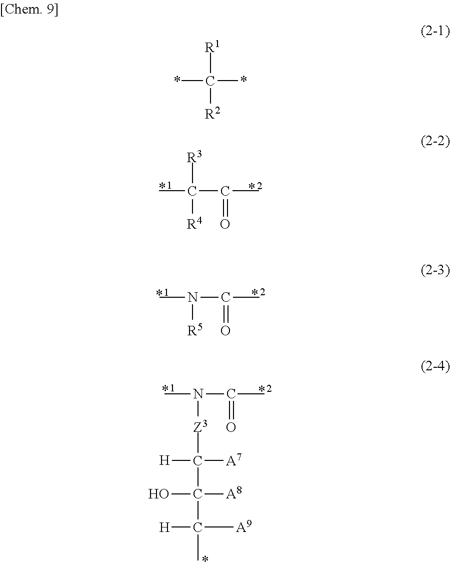

(In Formulas (2-1) to (2-3), R¹ to R⁵ each independently represent a hydrogen atom, an alkyl group having 1 to 10 carbon atoms which may be interrupted with an oxygen atom or a sulfur atom, an alkenyl group having 2 to 10 carbon atoms which may be interrupted with an oxygen atom or a sulfur atom, an alkynyl group having 2 to 10 carbon atoms which may be interrupted with an oxygen atom or a sulfur atom, a benzyl group, or a phenyl group, and the phenyl group may be substituted with at least one monovalent group selected from the group consisting of an alkyl group having 1 to 6 carbon atoms, a halogen atom, an alkoxy group having 1 to 6 carbon atoms, a nitro group, a cyano group, and an alkylthio group having 1 to 6 carbon atoms. R¹ and R² may be bonded to each other to form a ring having 3 to 6 carbon atoms. R³ and R⁴ may be bonded to each other to form a ring having 3 to 6 carbon atoms.

In Formula (2-4), Z³ represents a single bond or a divalent group represented by the following Formula (2-5) (in Formula (2-5), *3 represents a bond bonded to a nitrogen atom in Formula (2-4)). A⁷, A⁸, and A⁹ each independently represent a hydrogen atom, a methyl group, or an ethyl group.
* represents a bond. *1 represents a bond bonded to a carbon atom in Formula (2). *2 represents a bond bonded to a nitrogen atom in Formula (2).)

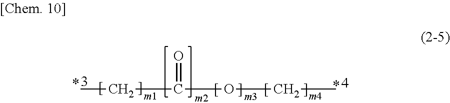

(In Formula (2-5), m1 is an integer of 0 to 4, m2 is 0 or 1, m3 is 0 or 1, and m4 is an integer of 0 to 2, provided that, when m3 is 1, m1 and m2 are not both 0 at the same time. *3 represents a bond bonded to a nitrogen atom in Formula (2) or (2-4). *4 represents a bond bonded to a carbon atom in Formula (2) or (2-4).)

In the present specification, examples of the halogen atom include fluorine atom, chlorine atom, bromine atom, and iodine atom.

In the present specification, the alkyl group is not limited to a linear one, and may be branched or cyclic. Examples of the linear or branched alkyl group include methyl group, ethyl group, isopropyl group, tert-butyl group, and n-hexyl group. Examples of the cyclic alkyl group (cycloalkyl group) include cyclobutyl group, cyclopentyl group, and cyclohexyl group.

In the present specification, examples of the alkoxy group include methoxy group, ethoxy group, n-pentyloxy group, and isopropoxy group.

In the present specification, examples of the alkylthio group include methylthio group, ethylthio group, n-pentylthio group, and isopropylthio group.

In the present specification, examples of the alkenyl group include ethenyl group, 1-propenyl group, 2-propenyl group, 1-methyl-1-ethenyl group, 1-butenyl group, 2-butenyl group, 3-butenyl group, 2-methyl-1-propenyl group, and 2-methyl-2-propenyl group.

In the present specification, examples of the alkynyl group include a group in which a double bond of an alkenyl group listed in “alkenyl group” described above is substituted with a triple bond.

In the present specification, examples of the alkenyloxy group include vinyloxy group, 1-propenyloxy group, 2-n-propenyloxy group (allyloxy group), 1-n-butenyloxy group, and prenyloxy group.

In the present specification, examples of the alkynyloxy group include 2-propynyloxy group, 1-methyl-2-propynyloxy group, 2-methyl-2-propynyloxy group, 2-butynyloxy group, and 3-butynyloxy group.

In the present specification, examples of the acyl group include acetyl group and propionyl group.

In the present specification, examples of the aryloxy group include phenoxy group and naphthyloxy.

In the present specification, examples of the arylcarbonyl group include phenylcarbonyl group.

In the present specification, examples of the aralkyl group include benzyl group and phenethyl group.

In the present specification, examples of the alkylene group include methylene group, ethylene group, 1,3-propylene group, 2,2-propylene group, 1-methylethylene group, 1,4-butylene group, 1-ethylethylene group, 1-methylpropylene group, 2-methylpropylene group, 1,5-pentylene group, 1-methylbutylene group, 2-methylbutylene group, 1,1-dimethylpropylene group, 1,2-dimethylpropylene group, 1-ethylpropylene group, 2-ethylpropylene group, 1,6-hexylene group, 1,4-cyclohexylene group, 1,8-octylene group, 2-ethyloctylene group, 1,9-nonylene group, and 1,10-decylene group.

Examples of the alkyl group having 1 to 10 carbon atoms which may be interrupted with an oxygen atom or a sulfur atom in R¹ to R⁵ in Formulas (2-1) to (2-3) include an alkyl group having 1 to 10 carbon atoms, an alkoxy group having 1 to 10 carbon atoms, an alkoxyalkyl group having 2 to 10 carbon atoms, an alkoxyalkoxyalkyl group having 3 to 10 carbon atoms, an alkylthio group having 1 to 10 carbon atoms, and an alkylthioalkyl group having 2 to 10 carbon atoms.

In addition, the alkyl group having 1 to 10 carbon atoms which may be interrupted with an oxygen atom or a sulfur atom may include two or more oxygen atoms or sulfur atoms.
Q¹ in Formula (3) is preferably represented by the following Formula (3-1) or (3-2).

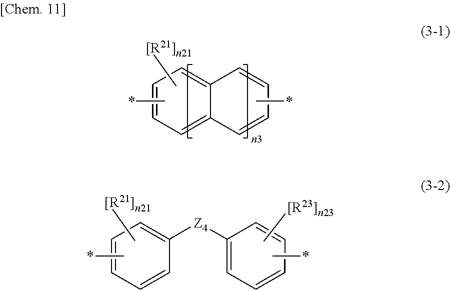

(In Formulas (3-1) and (3-2), R²¹ to R²³ each independently represent a halogen atom, a hydroxy group, an alkyl group having 1 to 6 carbon atoms, an alkenyl group having 2 to 6 carbon atoms, an alkynyl group having 2 to 6 carbon atoms, an alkoxy group having 1 to 6 carbon atoms, an alkenyloxy group having 2 to 6 carbon atoms, an alkynyloxy group having 2 to 6 carbon atoms, an acyl group having 2 to 6 carbon atoms, an aryloxy group having 6 to 12 carbon atoms, an arylcarbonyl group having 7 to 13 carbon atoms, or an aralkyl group having 7 to 13 carbon atoms. * represents a bond.

In Formula (3-1), n3 represents 0 or 1. When n3 is 0, n21 represents an integer of 0 to 4. When n3 is 1, n21 represents an integer of 0 to 6. When two or more R²¹'s are present, the two or more R²¹'s may be the same or different.

In Formula (3-2), Z⁴ represents a single bond, an oxygen atom, a sulfur atom, a carbonyl group, a sulfonyl group, or an alkylene group having 1 to 6 carbon atoms. n22 and n23 each independently represent an integer of 0 to 4. When two or more R²²'s are present, the two or more R²²'s may be the same or different. When two or more R²³'s are present, the two or more R²³'s may be the same or different.)

Examples of the following Formula (2X) in Formula (2) include a structure shown below.

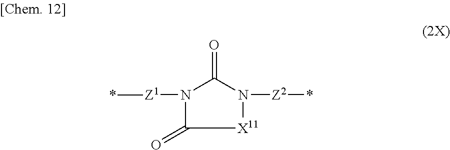

(In Formula (2X), X¹¹, Z¹, and Z² are synonymous with X¹¹, Z¹, and Z² in Formula (2), respectively. * represents a bond.)

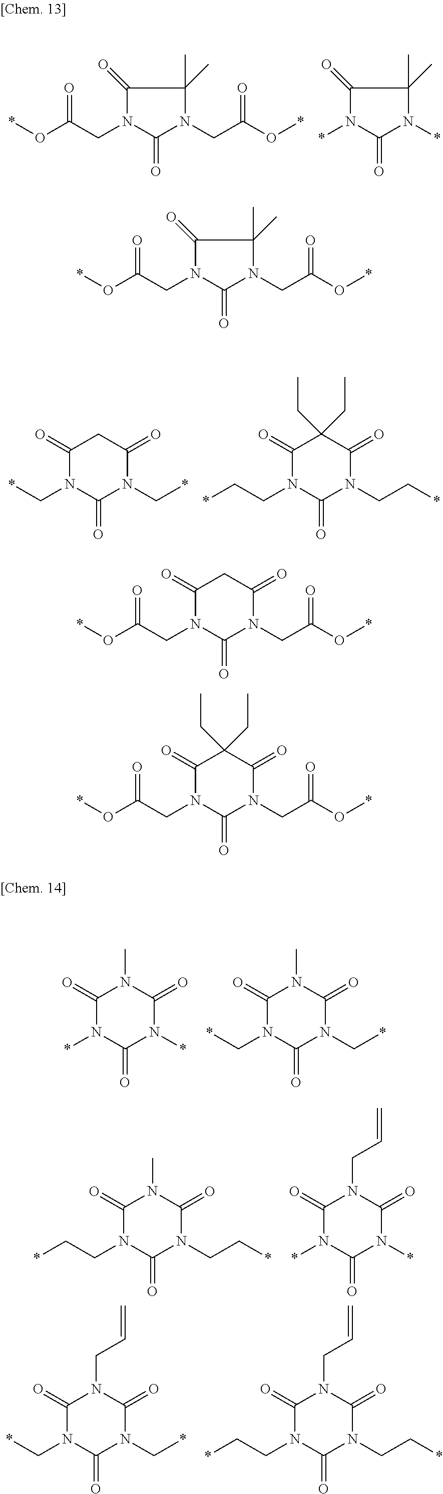

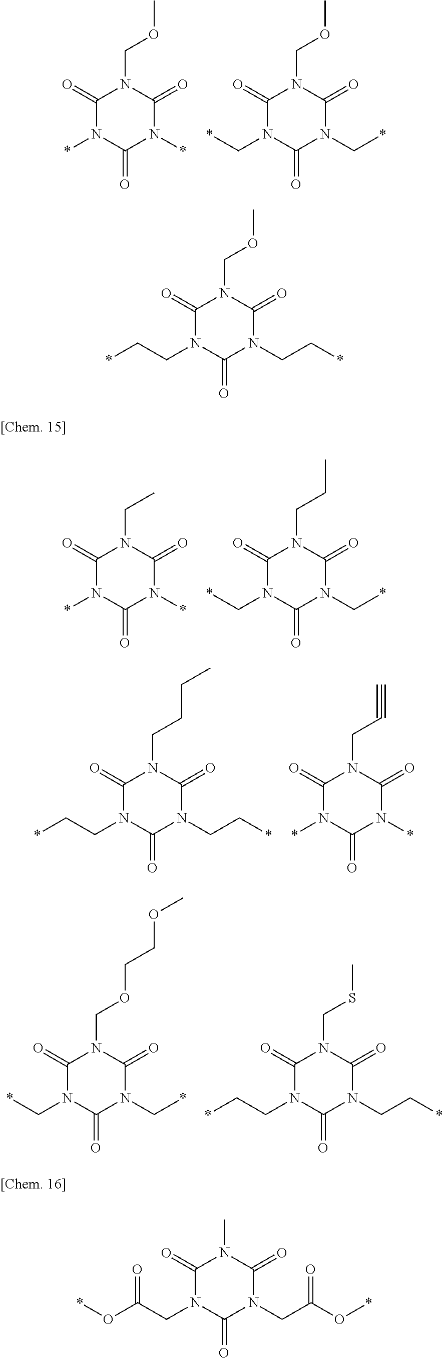

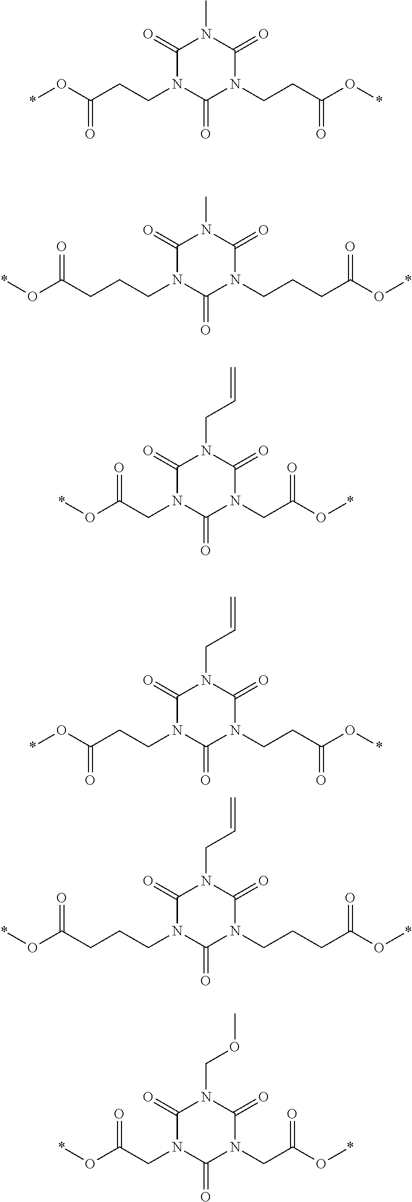

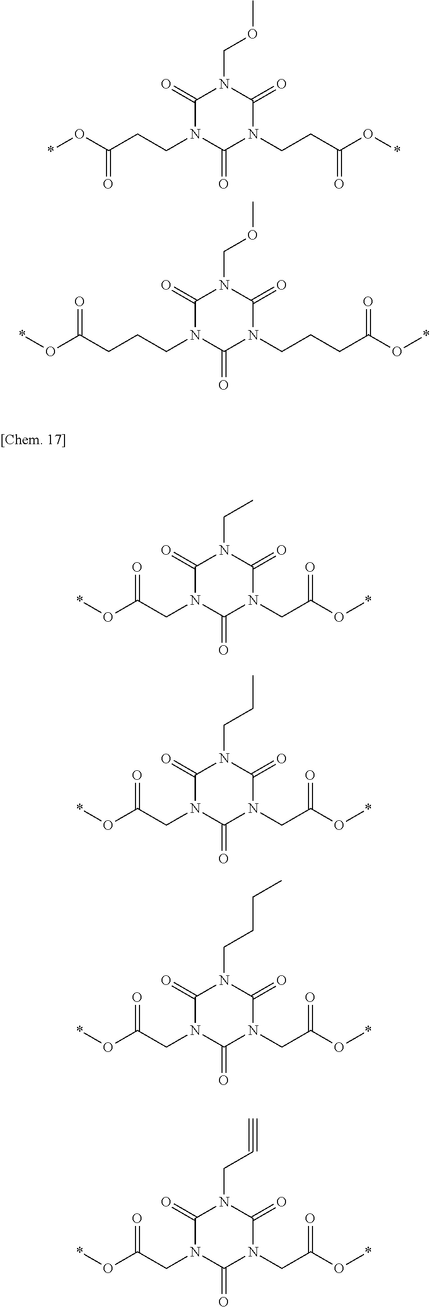

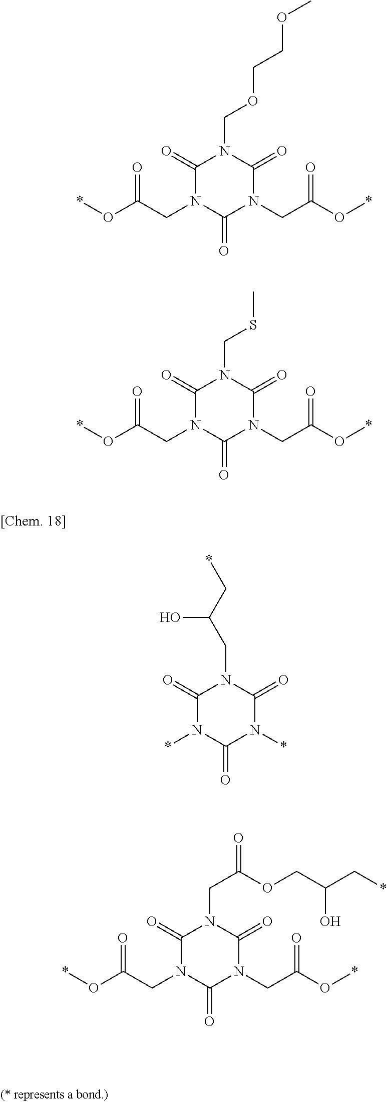 [SMILES: *OC(=O)Cn1c(=O)n(COCCOC)c(=O)n(CC(=O)O*)c1=O ; *OC(=O)Cn1c(=O)n(CSC)c(=O)n(CC(=O)O*)c1=O ; *CC(O)Cn1c(=O)n(*)c(=O)n(*)c1=O ; *CC(O)COC(=O)Cn1c(=O)n(CC(=O)O*)c(=O)n(CC(=O)O*)c1=O]

Examples of the following Formula (3X) in Formula (3) include a structure shown below.

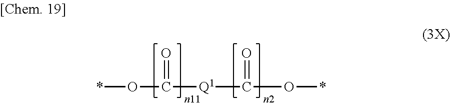

(In Formula (3X), Q¹, n11, and n12 are synonymous with Q¹, n11, and n12 in Formula (3), respectively, provided that at least one of n11 and n12 is 1. * represents a bond.)

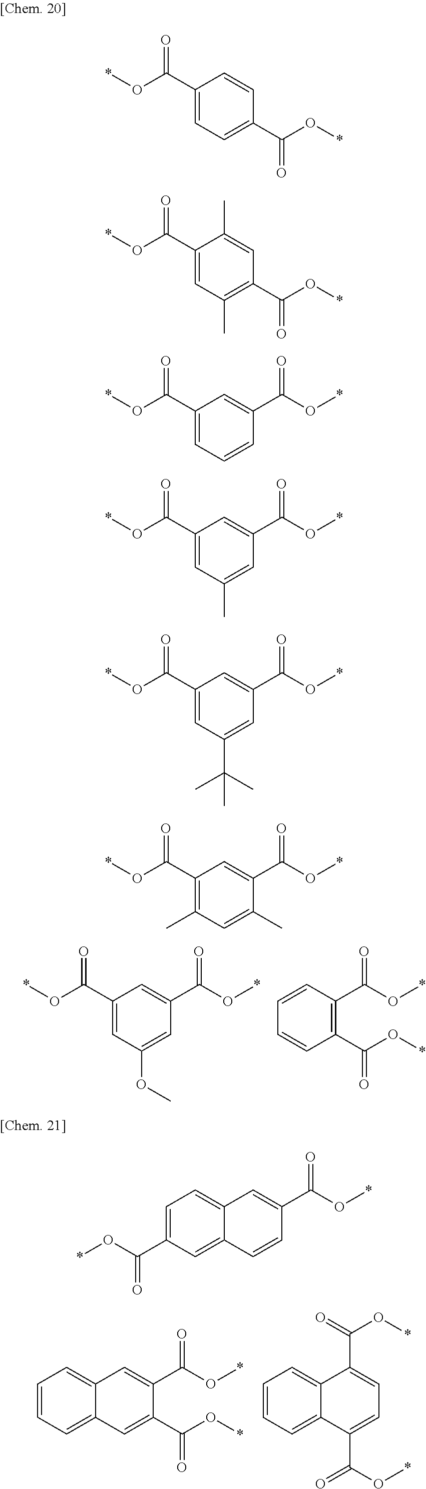

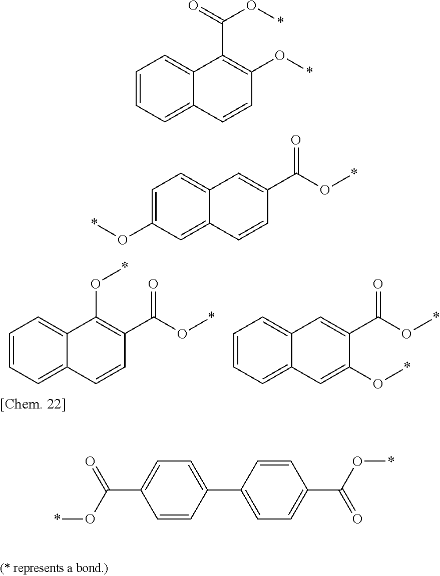

### <<Other Components>>

The specific compound and polymer may have a structure other than the structure represented by Formula (1) and the carbonyl bond. As such a structure, a structure represented by the following formula (E) is preferable from the viewpoint of an improvement in crosslinking efficiency and removability.

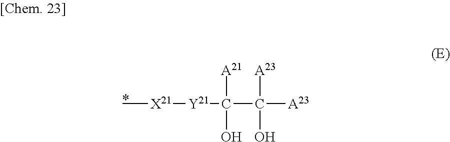

(In Formula (E), X²¹ represents —COO—, —OCO—, —O—, —S—, or —NR^{a}—, and R^{a} represents a hydrogen atom or a methyl group. Y²¹ represents a direct bond or an alkylene group having 1 to 4 carbon atoms which may be substituted. A²¹ to A²³ each independently represent a hydrogen atom, an alkyl group having 1 to 10 carbon atoms which may be substituted, or an aryl group having 6 to 40 carbon atoms which may be substituted. * represents a bond.)

Regarding Y²¹ and A²¹ to A²³ in Formula (E), the phrase “which may be substituted” means that some or all hydrogen atoms present in the functional group to be substituted may be each independently substituted with, for example, a hydroxy group, a halogen atom, a carboxy group, a nitro group, a cyano group, a methylenedioxy group, an acetoxy group, a methylthio group, an amino group, or an alkoxy group having 1 to 9 carbon atoms.

As X²¹, —S— is preferable.

The alkylene group having 1 to 4 carbon atoms which may be substituted in Y² is not particularly limited, and is preferably a methylene group.

The aryl group having 6 to 40 carbon atoms which may be substituted in A²¹ to A²³ is not particularly limited, and examples thereof include phenyl group, o-methylphenyl group, m-methylphenyl group, p-methylphenyl group, o-chlorophenyl group, m-chlorophenyl group, p-chlorophenyl group, o-fluorophenyl group, p-fluorophenyl group, o-methoxyphenyl group, p-methoxyphenyl group, p-nitrophenyl group, p-cyanophenyl group, α-naphthyl group, β-naphthyl group, o-biphenylyl group, m-biphenylyl group, p-biphenylyl group, 1-anthryl group, 2-anthryl group, 9-anthryl group, 1-phenanthryl group, 2-phenanthryl group, 3-phenanthryl group, 4-phenanthryl group, and 9-phenanthryl group.

The specific compound and polymer are preferably compounds represented by the following Formula (1-2) as compounds having a structure represented by Formula (1) and a carbonyl bond.

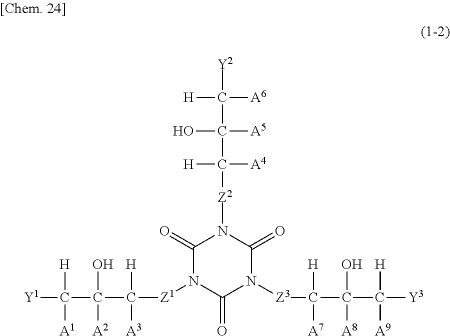

(In Formula (1-2), Z¹, Z², A¹, A², A³, A⁴, A⁵, and A⁶ are synonymous with Z¹, Z², A¹, A², A³, A⁴, A⁵, and A⁶ in Formula (2), respectively.
Z³, A⁷, A⁸, and A⁹ are synonymous with Z³, A⁷, A⁸, and A⁹ in Formula (2-4), respectively.
Y¹, Y², and Y³ each independently represent a structure represented by the following Formula (1X) or a structure represented by Formula (E). At least one of Y¹ to Y³ represents a structure represented by Formula (1X).)

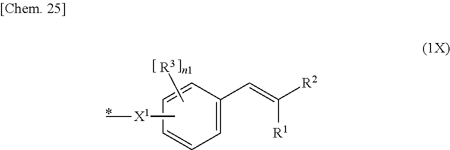

(In Formula (1X), X¹, R³, and n1 are synonymous with X¹, R³, and n1 in Formula (1), respectively. R¹ and R² each independently represent a hydrogen atom, a cyano group, a phenyl group, an alkyl group having 1 to 13 carbon atoms, a halogen atom, or —COOR¹¹ (R¹¹ represents a hydrogen atom or an alkyl group having 1 to 4 carbon atoms). * represents a bond.)

The specific compound and polymer preferably have, as a structure having “a structure represented by Formula (1) and a carbonyl bond”, at least one of a structure represented by the following Formula (1-3) and a structure represented by the following Formula (1-4). The structure represented by Formula (1-3) may be a repeating unit in the polymer. The structure represented by Formula (1-4) may be a repeating unit in the polymer.

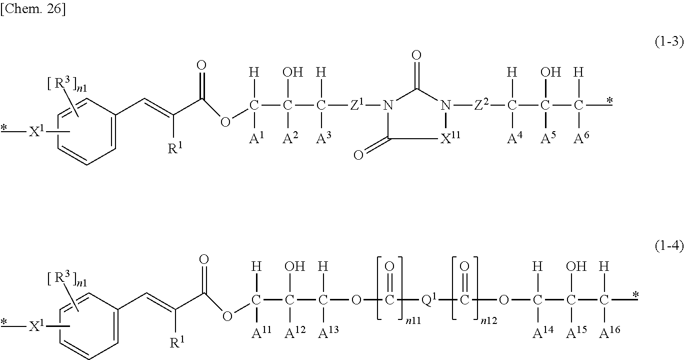

(In Formulas (1-3) and (1-4), X¹, R³, and n1 are synonymous with X, R³, and n1 in Formula (1), respectively.

In Formula (1-3), X¹¹, Z¹, Z², A¹, A², A³, A⁴, A⁵, and A⁶ are synonymous with X¹¹, Z¹, Z², A¹, A², A³, A⁴, A⁵, and A⁶ in Formula (2), respectively.

In Formula (1-3), R¹ represents a hydrogen atom, a cyano group, a phenyl group, an alkyl group having 1 to 13 carbon atoms, a halogen atom, or —COOR¹¹ (R¹¹ represents a hydrogen atom or an alkyl group having 1 to 4 carbon atoms).

In Formula (1-4), Q¹, A¹¹, A¹², A¹³, A¹⁴, A¹⁵, A¹⁶, n11, and n12 are synonymous with Q¹, A¹¹, A¹², A¹³, A¹⁴, A¹⁵, A¹⁶, n11, and n12 in Formula (3), respectively, provided that at least one of n11 and n12 is 1.
* represents a bond.)

The weight average molecular weight of the compound or polymer is, for example, 300 to 100,000, preferably 300 to 50,000, more preferably 300 to 10,000, and particularly preferably 300 to 5,000.

A method for producing an example of the specific compound and polymer will be described.

An example of the specific compound and polymer is obtained by, for example, the following reactions (I) to (IV).
(I): A reaction in which a compound represented by the following Formula (1A) is reacted with a compound represented by the following Formula (2A), and then the obtained reaction product is further reacted with an active methylene compound (Ra—CH₂—Rb)
(II): A reaction in which a compound represented by the following Formula (1A) is reacted with a compound represented by the following Formula (2A) and a compound represented by the following Formula (EA), and then the obtained reaction product is further reacted with an active methylene compound (Ra—CH₂—Rb)

In these reactions, by using the active methylene compound such as malononitrile, malonic acid, or malonic acid ester, an aldehyde group can be converted into a “—CH═C(Ra) (Rb)” group by Knoevenagel condensation. Ra and Rb each are a cyano group or —COOR¹¹ (R¹¹ represents a hydrogen atom or an alkyl group having 1 to 4 carbon atoms).

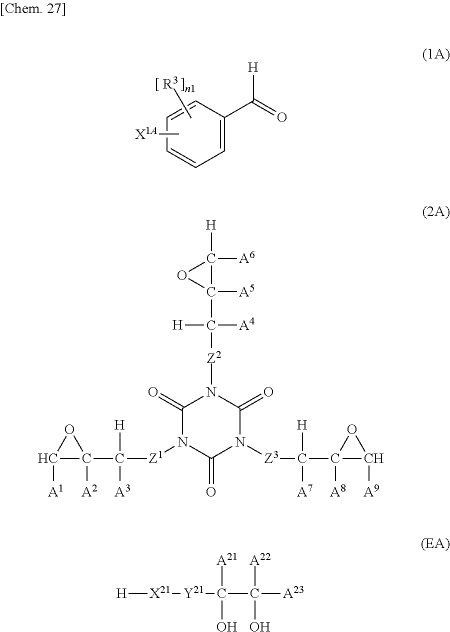

(In Formula (1A), X^{1A} represents a hydroxy group or a carboxy group.

In Formula (1A), R³ and n1 are synonymous with R³ and n1 in Formula (1), respectively.

In Formula (2A), Z¹, Z², A¹, A², A³, A⁴, A⁵, and A⁶ are synonymous with Z¹, Z², A¹, A², A³, A⁴, A⁵, and A⁶ in Formula (2), respectively.

In Formula (2A), Z³, A⁷, A⁸, and A⁹ are synonymous with Z³, A⁷, A⁸, and A⁹ in Formula (2-4), respectively.

In Formula (EA), X²¹, Y²¹, A²¹, A²², and A²³ are synonymous with X²¹, Y²¹, A²¹, A²², and A²³ in Formula (E), respectively.)
(III): A reaction between a compound represented by the following Formula (1B) and at least one of a compound represented by the following Formula (2B) and a compound represented by the following Formula (3B)
(IV): A reaction between a compound represented by the following Formula (1C) and at least one of a compound represented by the following Formula (2B) and a compound represented by the following formula (3B)

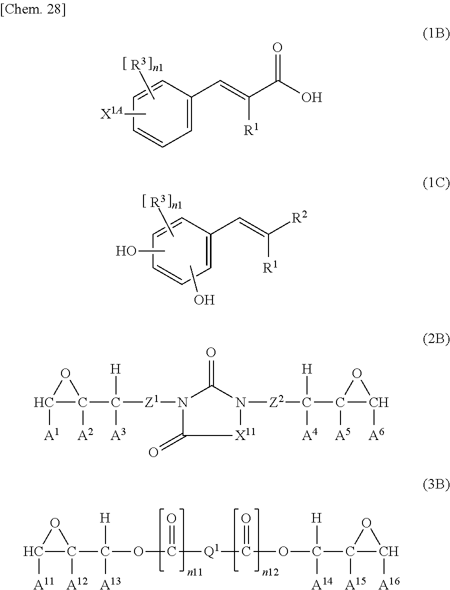

(In Formula (1B), X^{1A} represents a hydroxy group or a carboxy group.

In Formula (1B), R³ and n1 are synonymous with R³ and n1 in Formula (1), respectively. R′ represents a hydrogen atom, a cyano group, a phenyl group, an alkyl group having 1 to 13 carbon atoms, a halogen atom, or —COOR¹¹ (R¹¹ represents a hydrogen atom or an alkyl group having 1 to 4 carbon atoms).

In Formula (1C), R³ and n1 are synonymous with R³ and n1 in Formula (1), respectively. R¹ and R² each independently represent a hydrogen atom, a cyano group, a phenyl group, an alkyl group having 1 to 13 carbon atoms, a halogen atom, or —COOR¹¹ (R¹¹ represents a hydrogen atom or an alkyl group having 1 to 4 carbon atoms).

In Formula (2B), X¹¹, Z¹, Z², A¹, A², A³, A⁴, A⁵, and A⁶ are synonymous with X¹¹, Z¹, Z², A¹, A², A³, A⁴, A⁵, and A⁶ in Formula (2), respectively.

In Formula (3B), Q¹, A¹¹, A¹², A¹³, A¹⁴, A¹⁵, A¹⁶, n11, and n12 are synonymous with Q¹, A¹¹, A¹², A¹³, A¹⁴, A¹⁵, A¹⁶, n11, and n12 in Formula (3), respectively, provided that at least one of n11 and n12 is 1.)

Examples of the compound represented by Formula (1A) include 4-hydroxybenzaldehyde and terephthalaldehyde acid. These can be used alone or in combination of two or more thereof.

Examples of the compound represented by Formula (1B) include α-cyano-4-hydroxycinnamic acid.

Examples of the compound represented by Formula (1C) include the following compound.

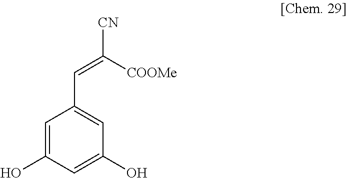

In the formula, Me represents a methyl group.

Examples of the compound represented by Formula (2A) or (2B) include the following compounds.

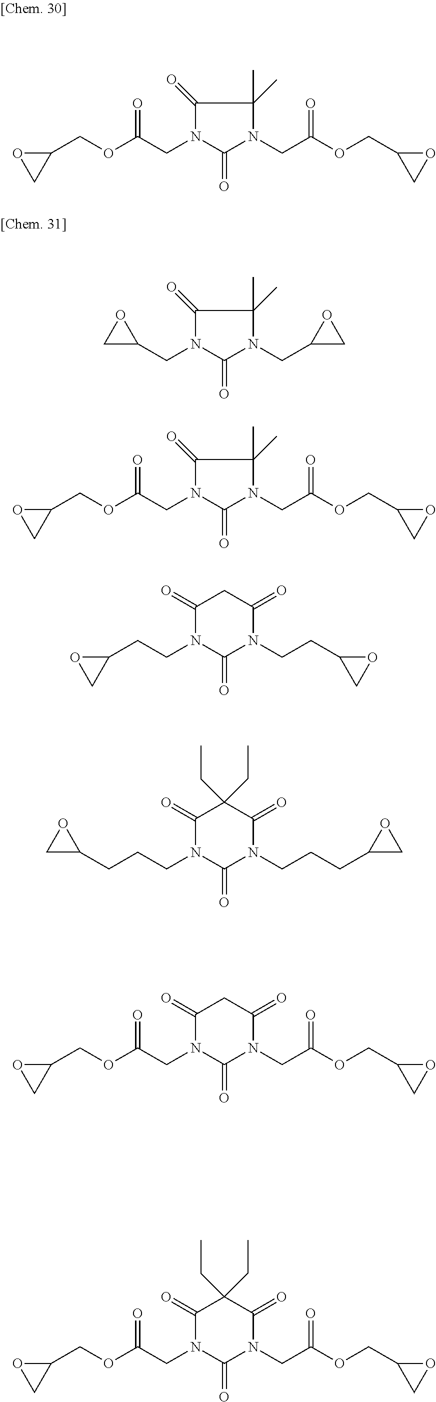

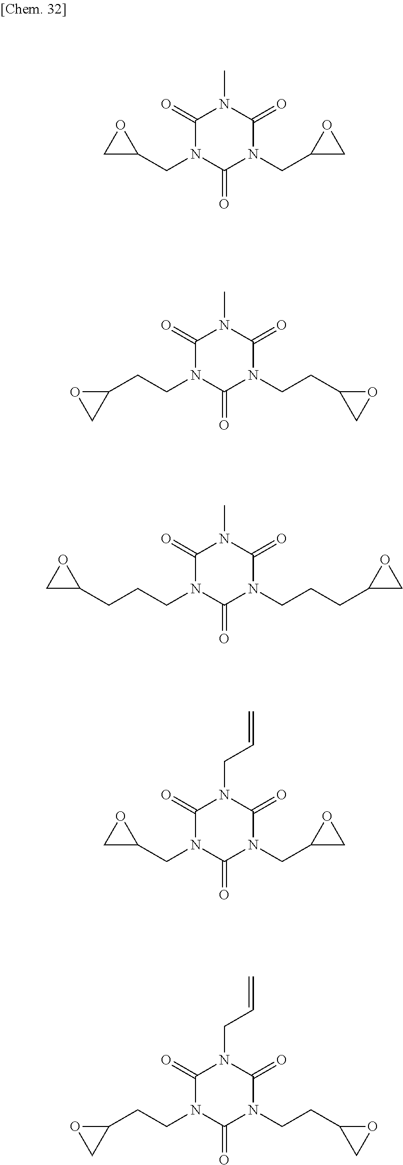 [SMILES: Cn1c(=O)n(CC2CO2)c(=O)n(CC2CO2)c1=O ; Cn1c(=O)n(CCC2CO2)c(=O)n(CCC2CO2)c1=O ; Cn1c(=O)n(CCCC2CO2)c(=O)n(CCCC2CO2)c1=O ; C=CCn1c(=O)n(CC2CO2)c(=O)n(CC2CO2)c1=O ; C=CCn1c(=O)n(CCC2CO2)c(=O)n(CCC2CO2)c1=O]

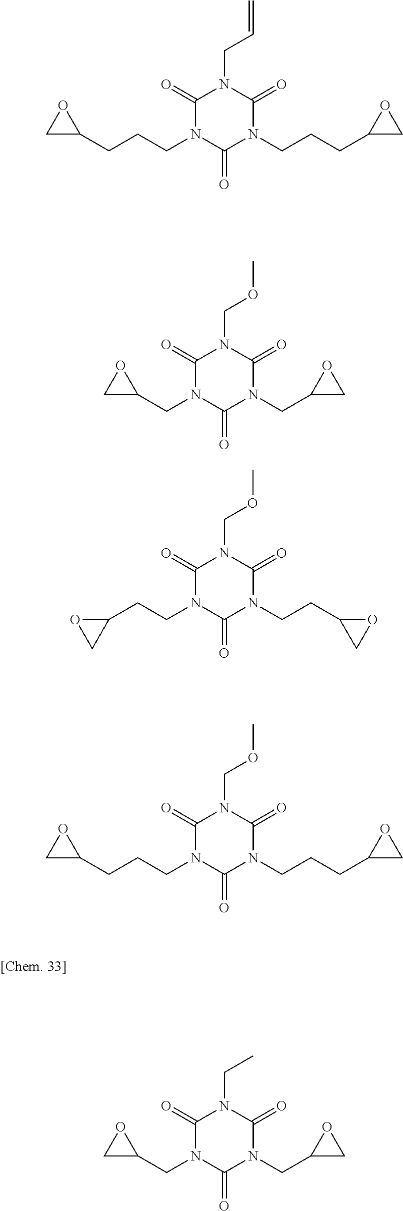

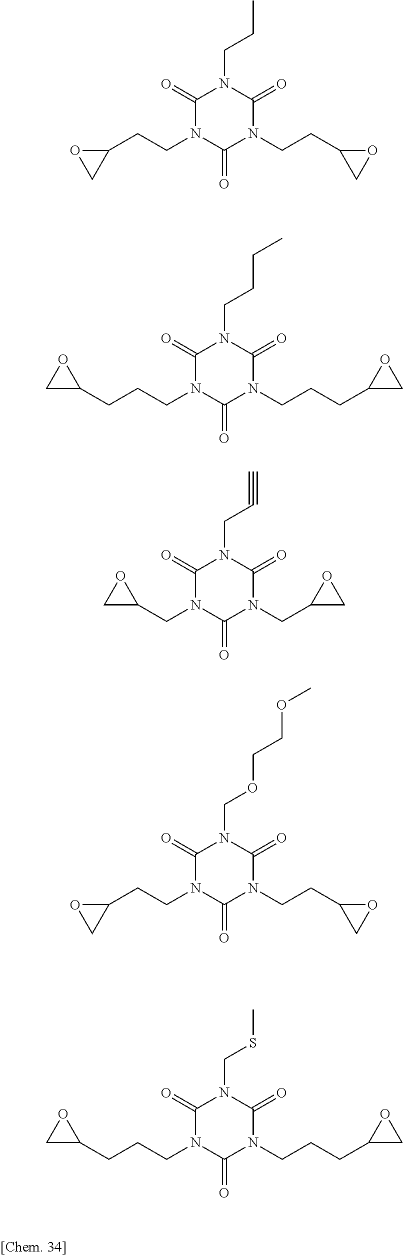

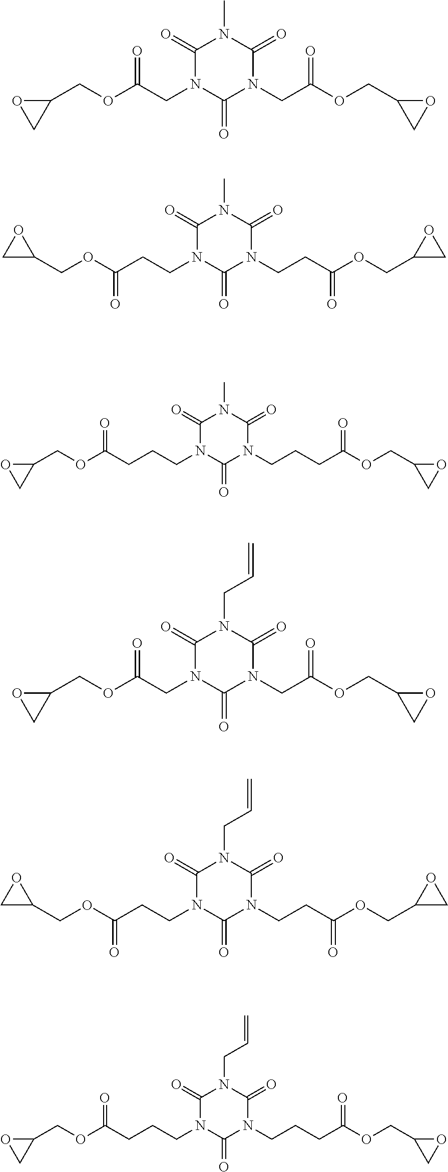 [SMILES: Cn1c(=O)n(CC(=O)OCC2CO2)c(=O)n(CC(=O)OCC2CO2)c1=O ; Cn1c(=O)n(CCC(=O)OCC2CO2)c(=O)n(CCC(=O)OCC2CO2)c1=O ; Cn1c(=O)n(CCCC(=O)OCC2CO2)c(=O)n(CCCC(=O)OCC2CO2)c1=O ; C=CCn1c(=O)n(CC(=O)OCC2CO2)c(=O)n(CC(=O)OCC2CO2)c1=O ; C=CCn1c(=O)n(CCC(=O)OCC2CO2)c(=O)n(CCC(=O)OCC2CO2)c1=O ; C=CCn1c(=O)n(CCCC(=O)OCC2CO2)c(=O)n(CCCC(=O)OCC2CO2)c1=O]

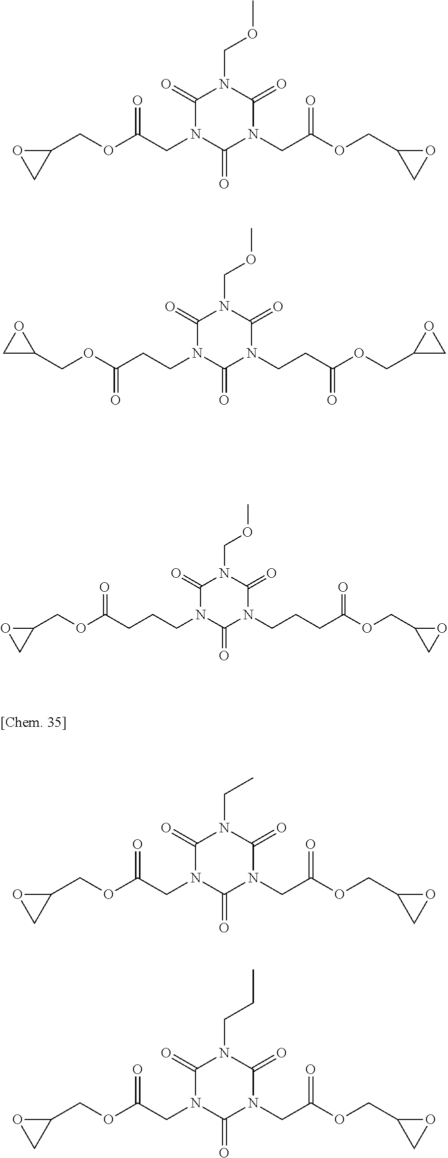 [SMILES: COCn1c(=O)n(CC(=O)OCC2CO2)c(=O)n(CC(=O)OCC2CO2)c1=O ; COCn1c(=O)n(CCC(=O)OCC2CO2)c(=O)n(CCC(=O)OCC2CO2)c1=O ; COCn1c(=O)n(CCCC(=O)OCC2CO2)c(=O)n(CCCC(=O)OCC2CO2)c1=O ; CCn1c(=O)n(CC(=O)OCC2CO2)c(=O)n(CC(=O)OCC2CO2)c1=O ; CCCn1c(=O)n(CC(=O)OCC2CO2)c(=O)n(CC(=O)OCC2CO2)c1=O]

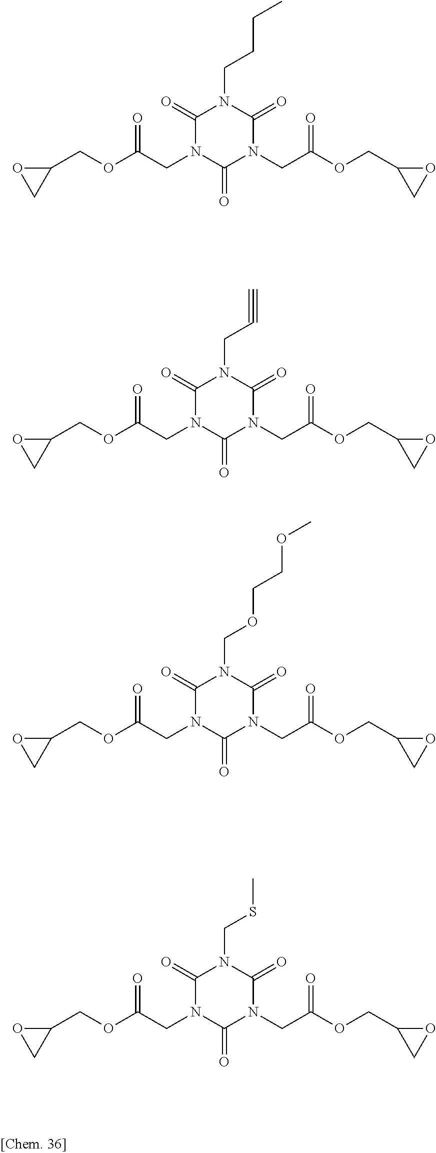 [SMILES: CCCCn1c(=O)n(CC(=O)OCC2CO2)c(=O)n(CC(=O)OCC2CO2)c1=O ; C#CCn1c(=O)n(CC(=O)OCC2CO2)c(=O)n(CC(=O)OCC2CO2)c1=O ; COCCOCn1c(=O)n(CC(=O)OCC2CO2)c(=O)n(CC(=O)OCC2CO2)c1=O ; CSCn1c(=O)n(CC(=O)OCC2CO2)c(=O)n(CC(=O)OCC2CO2)c1=O]

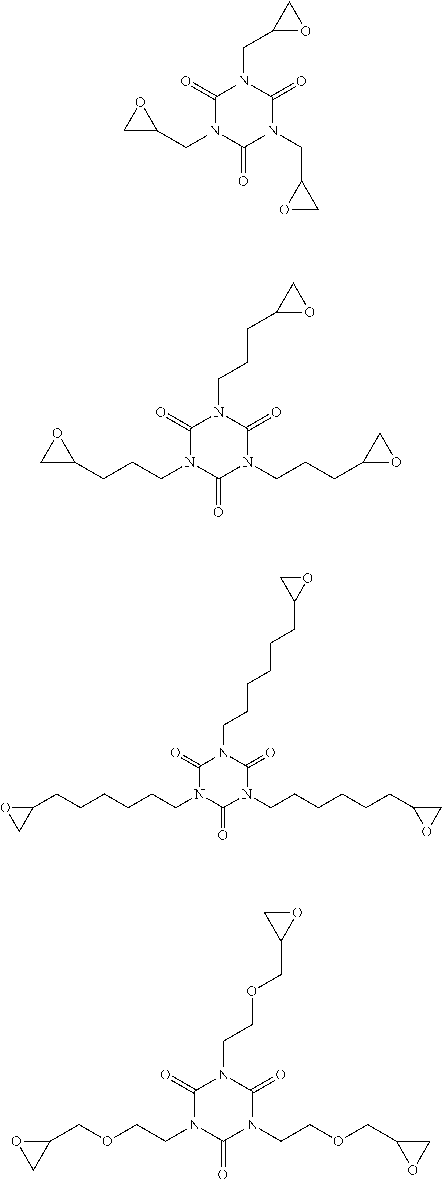 [SMILES: O=c1n(CC2CO2)c(=O)n(CC2CO2)c(=O)n1CC1CO1 ; O=c1n(CCCC2CO2)c(=O)n(CCCC2CO2)c(=O)n1CCCC1CO1 ; O=c1n(CCCCCCC2CO2)c(=O)n(CCCCCCC2CO2)c(=O)n1CCCCCCC1CO1 ; O=c1n(CCOCC2CO2)c(=O)n(CCOCC2CO2)c(=O)n1CCOCC1CO1]

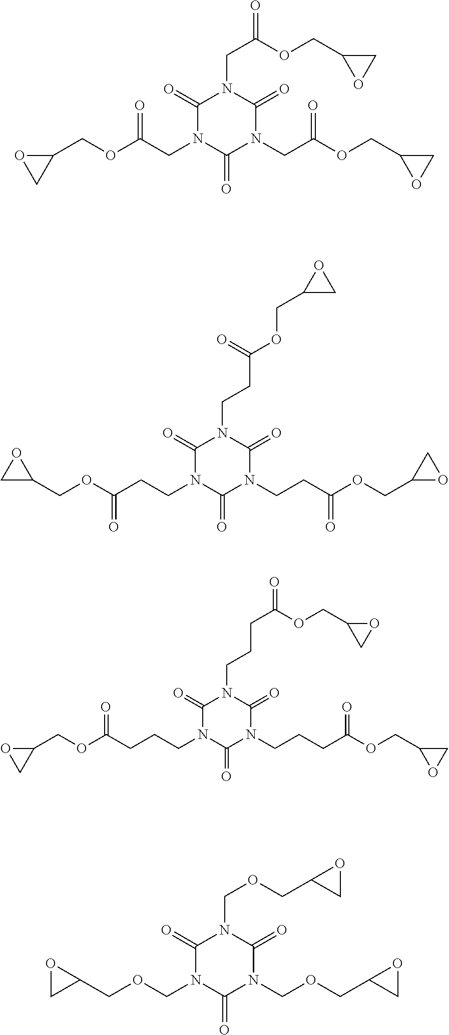 [SMILES: O=C(Cn1c(=O)n(CC(=O)OCC2CO2)c(=O)n(CC(=O)OCC2CO2)c1=O)OCC1CO1 ; O=C(CCn1c(=O)n(CCC(=O)OCC2CO2)c(=O)n(CCC(=O)OCC2CO2)c1=O)OCC1CO1 ; O=C(CCCn1c(=O)n(CCCC(=O)OCC2CO2)c(=O)n(CCCC(=O)OCC2CO2)c1=O)OCC1CO1 ; O=c1n(COCC2CO2)c(=O)n(COCC2CO2)c(=O)n1COCC1CO1]

Examples of the compound represented by Formula (3A) include the following compounds.

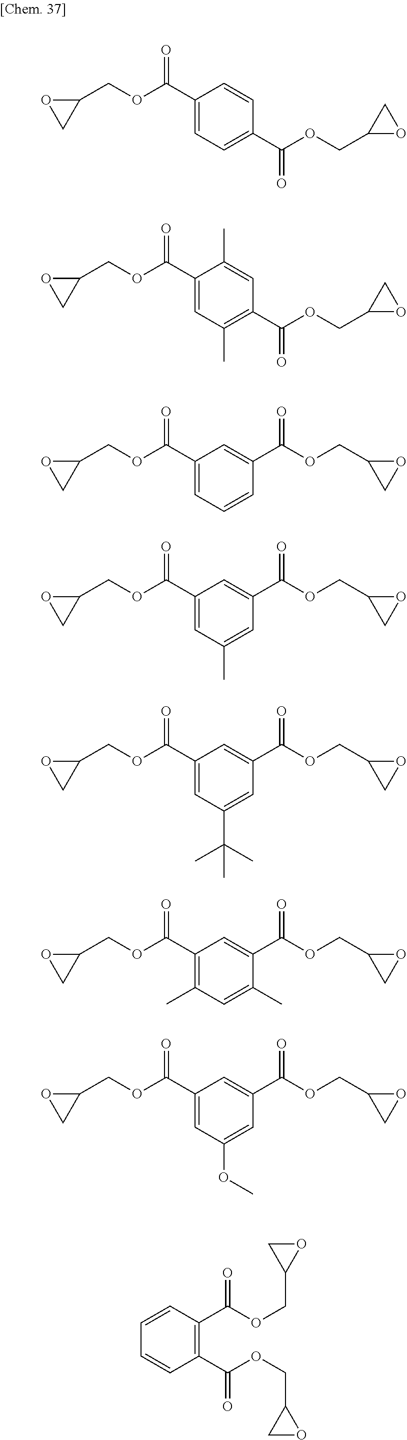

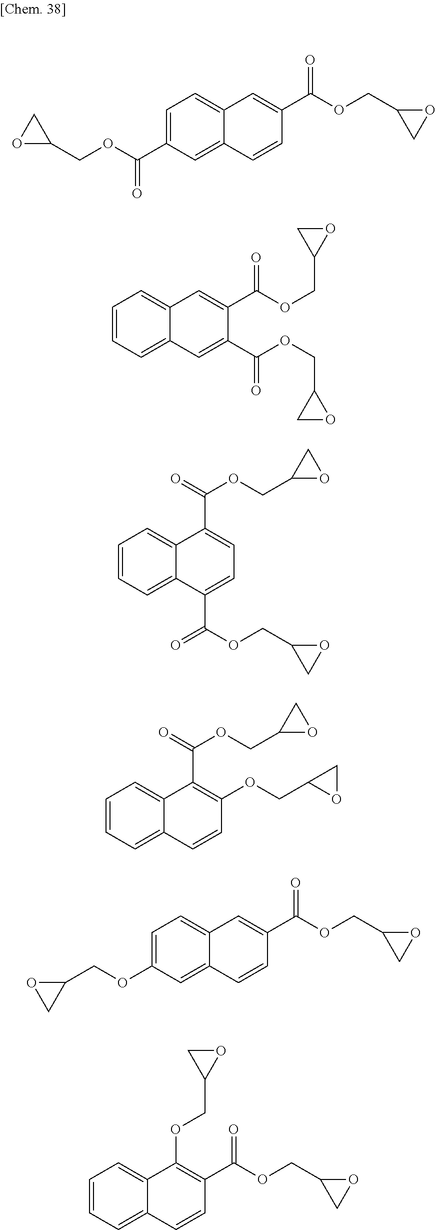

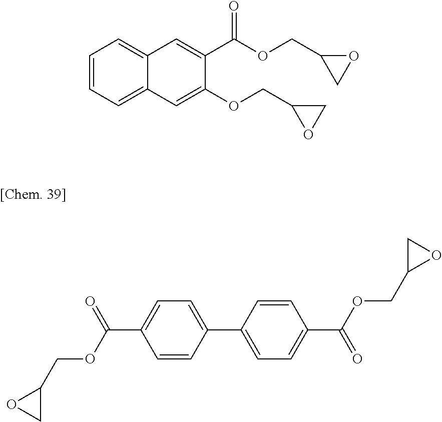 [SMILES: O=C(OCC1CO1)c1cc2ccccc2cc1OCC1CO1 ; O=C(OCC1CO1)c1ccc(-c2ccc(C(=O)OCC3CO3)cc2)cc1]

Examples of the compound represented by Formula (EA) include thioglycerol.

The reactions (I) to (VI) may be performed, for example, in the presence of a catalyst. The catalyst is, for example, a quaternary phosphonium salt such as tetrabutylphosphonium bromide or ethyltriphenylphosphonium bromide, or a quaternary ammonium salt such as benzyltriethylammonium chloride. Regarding the amount of the catalyst used, an appropriate amount can be selected and used from a range of 0.1 to 10 mass % relative to the total mass of the reaction raw material used in the reaction. Regarding the temperature and time for the reaction, for example, optimum conditions can be selected from a range of 80° C. to 160° C. and a range of 2 to 50 hours.

The content of the specific compound and polymer in the composition for forming a gap-filling material is not particularly limited, and is preferably 5 mass % to 99 mass, more preferably 10 mass % to 98 mass %, and particularly preferably 20 mass % to 95 mass % relative to the film constituent components in the composition for forming a gap-filling material.

The film constituent components refer to components other than the solvent in the composition for forming a gap-filling material.

### <Crosslinking Agent>

The composition for forming a gap-filling material preferably contains a crosslinking agent.

The crosslinking agent contained as an optional component in the composition for forming a gap-filling material has, for example, a functional group that reacts alone.

Examples of the crosslinking agent include hexamethoxymethylmelamine, tetramethoxymethylbenzoguanamine, 1,3,4,6-tetrakis(methoxymethyl)glycoluril (tetramethoxymethyl glycoluril) (POWDERLINK [registered trade name] 1174), 1,3,4,6-tetrakis(butoxymethyl)glycoluril, 1,3,4,6-tetrakis(hydroxymethyl)glycoluril, 1,3-bis(hydroxymethyl) urea, 1,1,3,3-tetrakis(butoxymethyl) urea, and 1,1,3,3-tetrakis(methoxymethyl) urea.

In addition, the crosslinking agent may be a nitrogen-containing compound having, in one molecule, 2 to 6 substituents represented by the following Formula (1d) bonded to a nitrogen atom, which is described in WO 2017/187969 A.

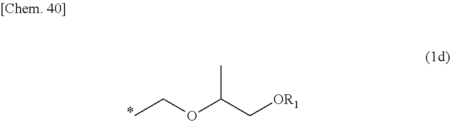

(In Formula (1d), R¹ represents a methyl group or an ethyl group. * represents a bond bonded to a nitrogen atom.)

The nitrogen-containing compound having 2 to 6 substituents represented by Formula (1d) in one molecule may be a glycoluril derivative represented by the following Formula (1E).

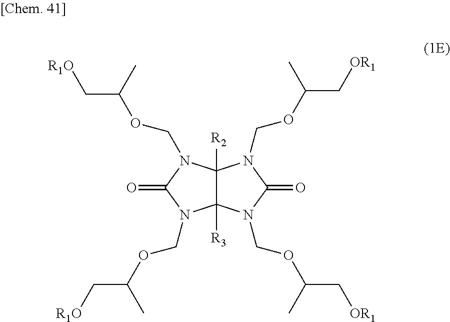

(In Formula (1E), four R₁'s each independently represent a methyl group or an ethyl group, and R₂ and R₃ each independently represent a hydrogen atom, an alkyl group having 1 to 4 carbon atoms, or a phenyl group.)

Examples of the glycoluril derivative represented by Formula (1E) include compounds represented by the following Formulas (1E-1) to (1E-6).

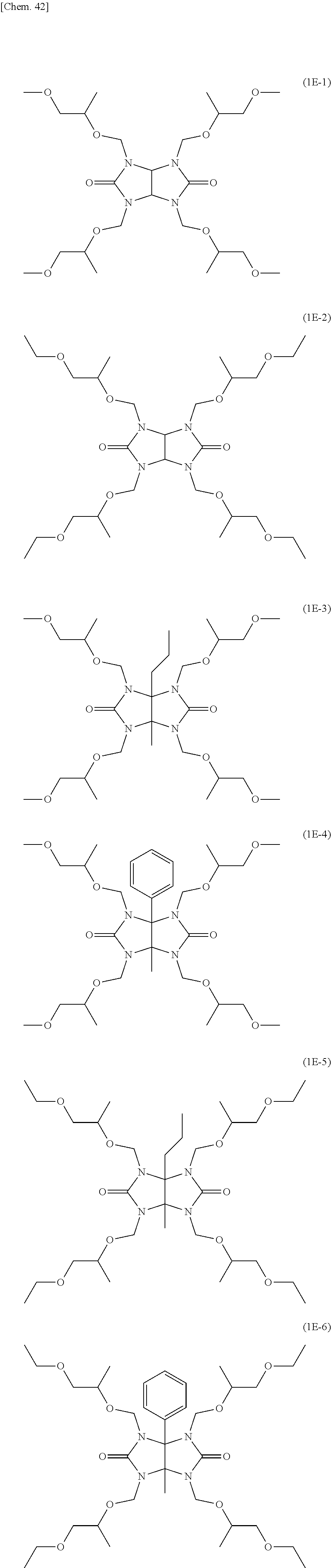

The nitrogen-containing compound having 2 to 6 substituents represented by the formula (1d) in one molecule is obtained by reacting a nitrogen-containing compound having, in one molecule, 2 to 6 substituents represented by the following formula (2d) bonded to a nitrogen atom with at least one compound represented by the following Formula (3d).

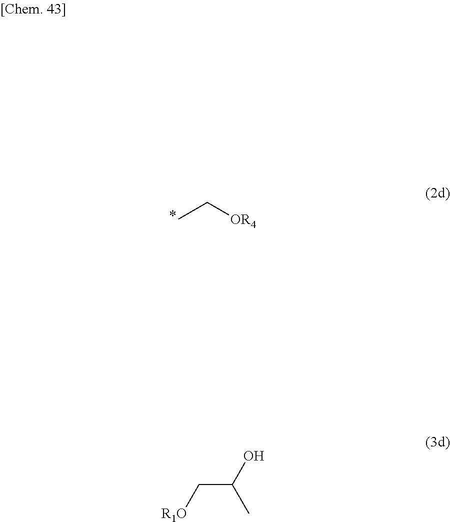

(In Formulas (2d) and (3d), R₁ represents a methyl group or an ethyl group, and R₄ represents an alkyl group having 1 to 4 carbon atoms. * represents a bond bonded to a nitrogen atom.)

The glycoluril derivative represented by Formula (1E) is obtained by reacting a glycoluril derivative represented by the following Formula (2E) with at least one compound represented by the following Formula (3d).

The nitrogen-containing compound having 2 to 6 substituents represented by Formula (2d) in one molecule may be a glycoluril derivative represented by the following Formula (2E).

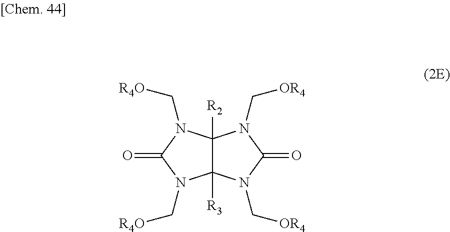

(In Formula (2E), R₂ and R₃ each independently represent a hydrogen atom, an alkyl group having 1 to 4 carbon atoms, or a phenyl group, and R₄'s each independently represent an alkyl group having 1 to 4 carbon atoms.)

Examples of the glycoluril derivative represented by Formula (2E) include compounds represented by the following Formulas (2E-1) to (2E-4). Furthermore, examples of the compound represented by Formula (3d) include compounds represented by the following Formulas (3d-1) and (3d-2).

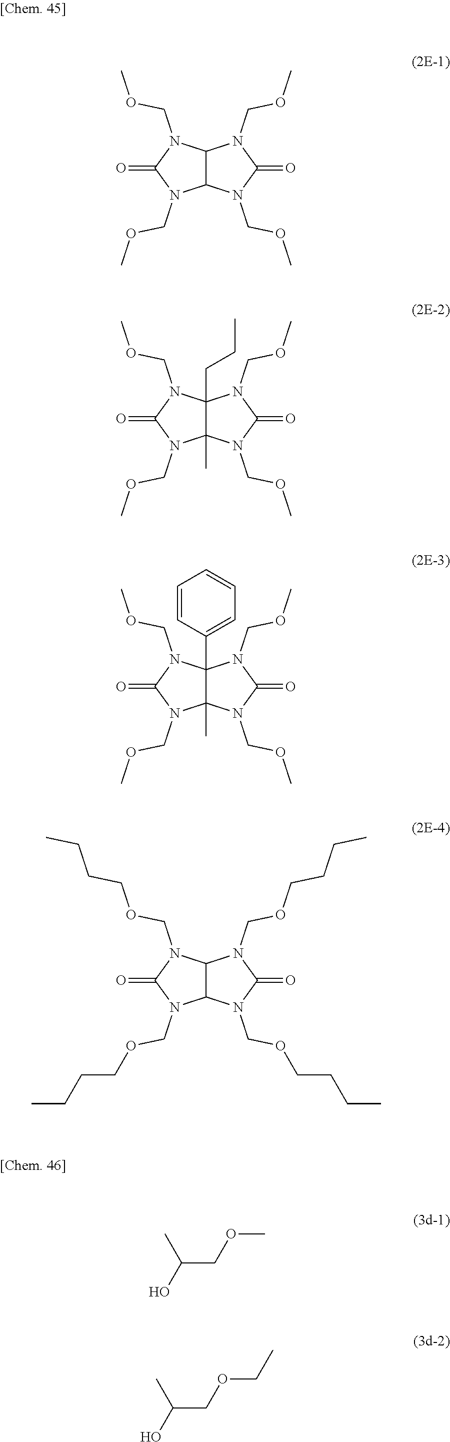

For the content related to the nitrogen-containing compound having, in one molecule, 2 to 6 substituents represented by Formula (1d) bonded to a nitrogen atom, the entire disclosure of WO 2017/187969 A is incorporated herein.

In addition, the crosslinking agent may be a crosslinkable compound represented by the following Formula (G-1) or (G-2) described in WO 2014/208542 A.

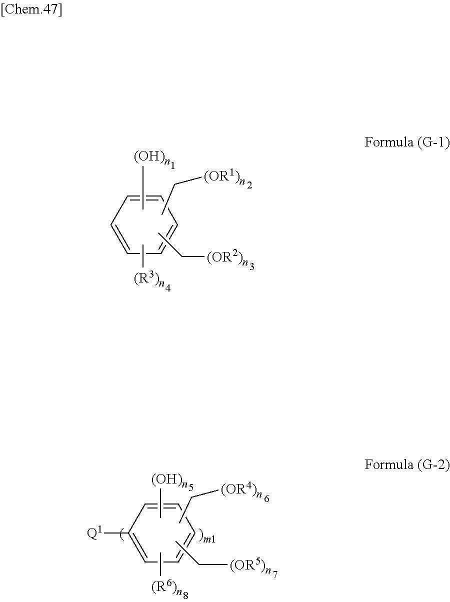

(In the formula, Q represents a single bond or an m1-valent organic group, R¹ and R⁴ each represent an alkyl group having 2 to 10 carbon atoms or an alkyl group having 2 to 10 carbon atoms having an alkoxy group having 1 to 10 carbon atoms, R² and R⁵ each represent a hydrogen atom or a methyl group, and R³ and Re each represent an alkyl group having 1 to 10 carbon atoms or an aryl group having 6 to 40 carbon atoms.
n1 represents an integer of 1≤n1≤3, n2 represents an integer of 2≤n2≤5, n3 represents an integer of 0≤n3≤3, n4 represents an integer of 0≤n4≤3, and 3≤(n1+n2+n3+n4)≤6.
n5 represents an integer of 1≤n5≤3, n6 represents an integer of 1≤n6≤4, n7 represents an integer of 0≤n7≤3, n8 represents an integer of 0≤n8≤3, and 2≤(n5+n6+n7+n8)≤5.
m1 represents an integer of 2 to 10.)

The crosslinkable compound represented by Formula (G-1) or (G-2) may be obtained by a reaction of a compound represented by the following Formula (G-3) or (G-4) with a hydroxyl group-containing ether compound or an alcohol having 2 to 10 carbon atoms.

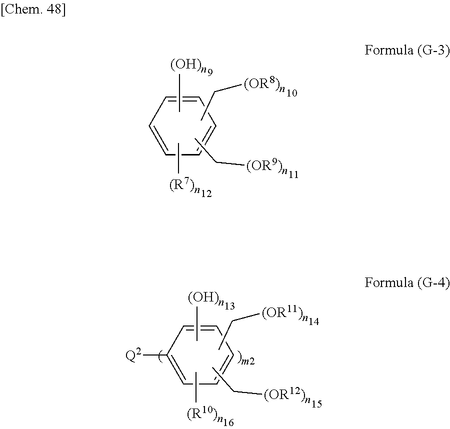

(In the formula, Q² represents a single bond or an m2-valent organic group. R⁸, R⁹, R¹¹, and R¹² each represent a hydrogen atom or a methyl group, and R⁷ and R¹⁰ each represent an alkyl group having 1 to 10 carbon atoms or an aryl group having 6 to 40 carbon atoms.
n9 represents an integer of 1≤n9≤3, n10 represents an integer of 2≤n10≤5, n11 represents an integer of 0≤n11≤3, n12 represents an integer of 0≤n12≤3, and 3≤(n9+n10+n11+n12)≤6.
n13 represents an integer of 1≤n13≤3, n14 represents an integer of 1≤n14≤4, n15 represents an integer of 0≤n15≤3, n16 represents an integer of 0≤n16≤3, and 2≤(n13+n14+n15+n16)≤5.
m2 represents an integer of 2 to 10.)

Examples of the compounds represented by Formulas (G-1) and (G-2) are shown below.

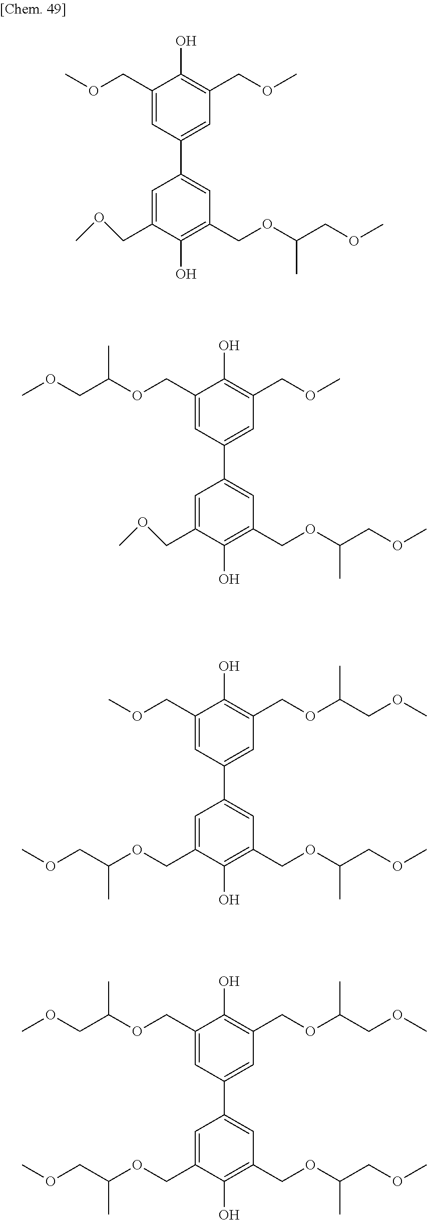

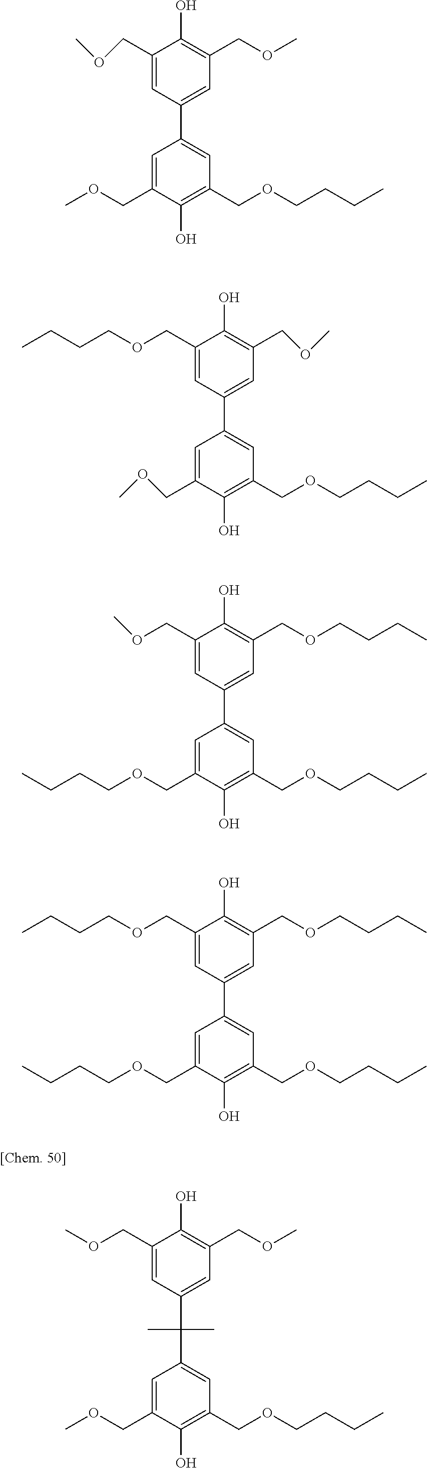

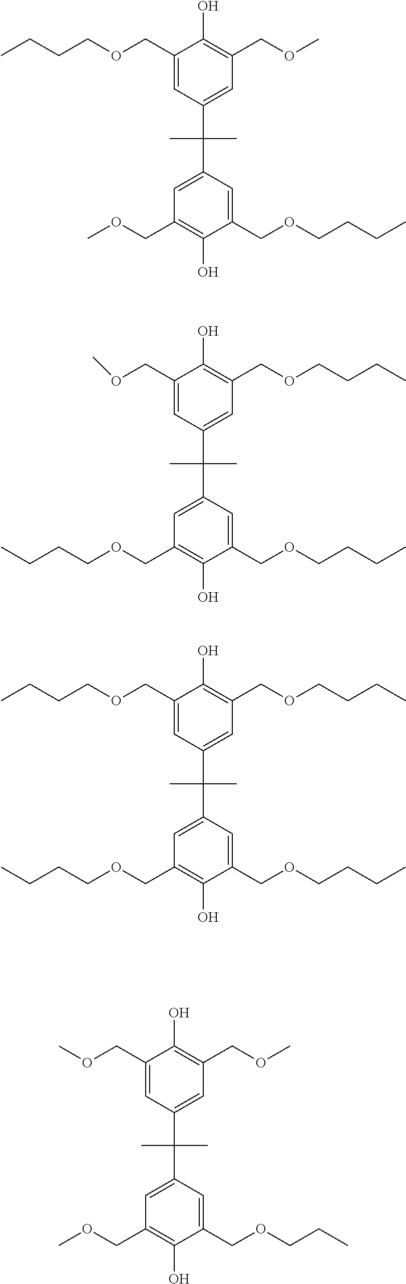

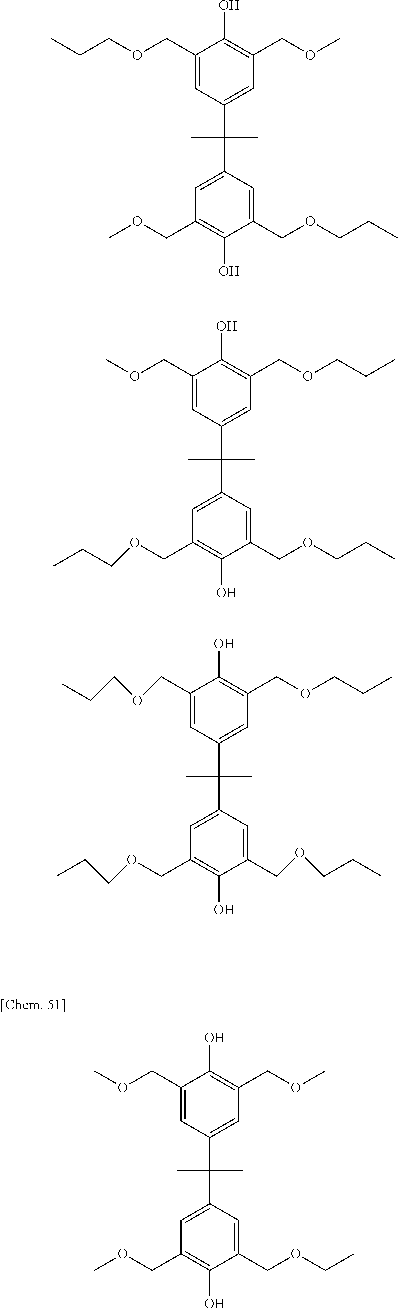

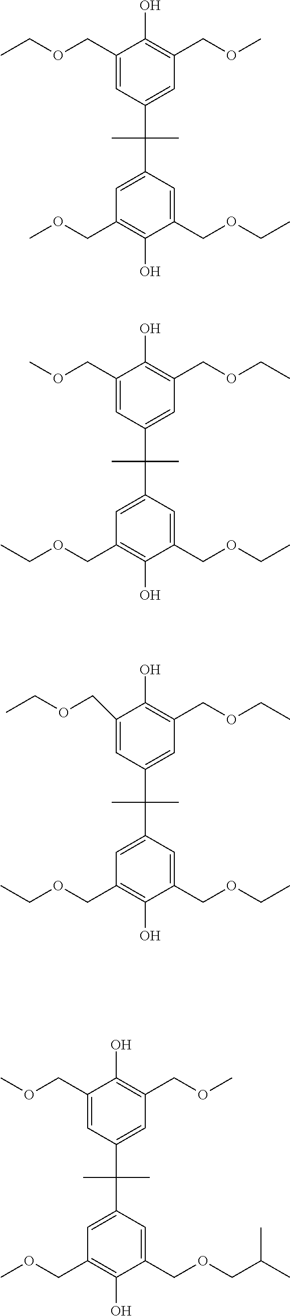

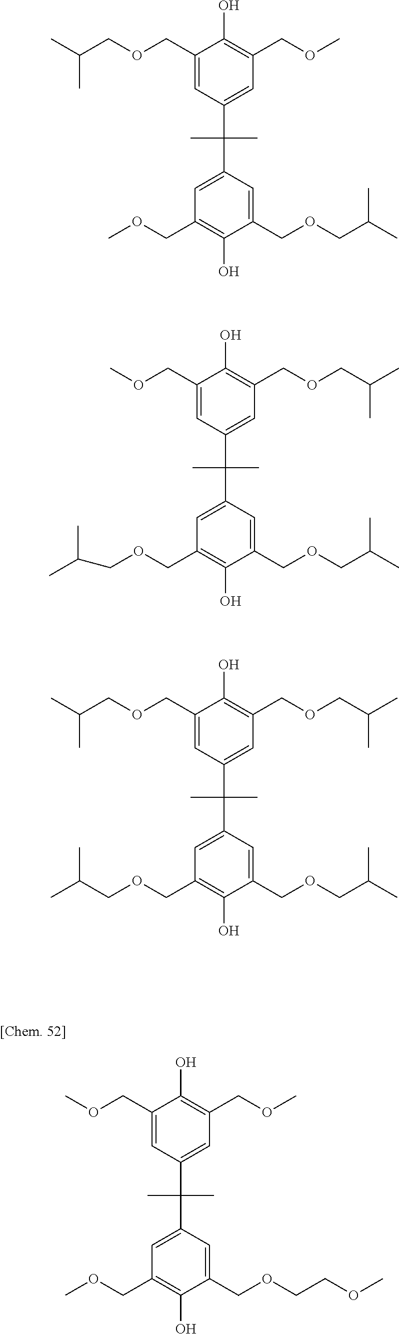

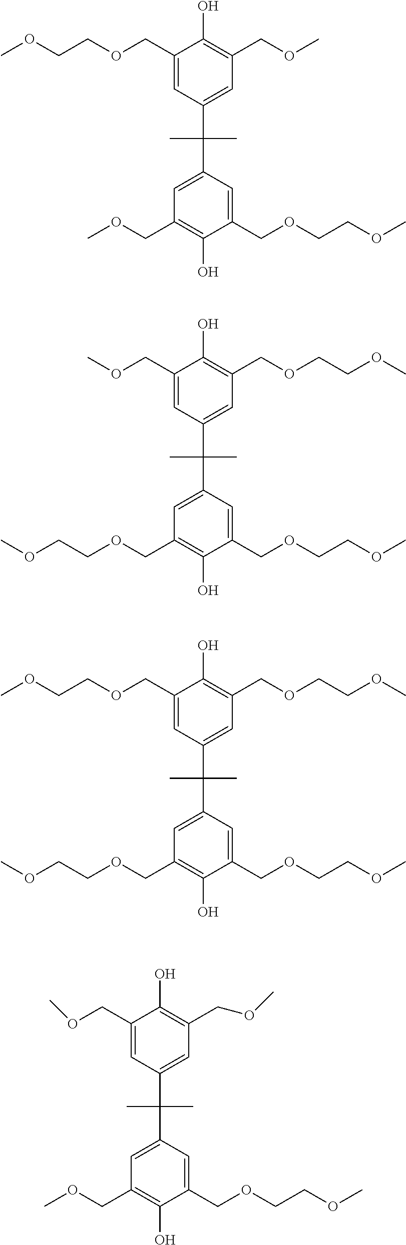

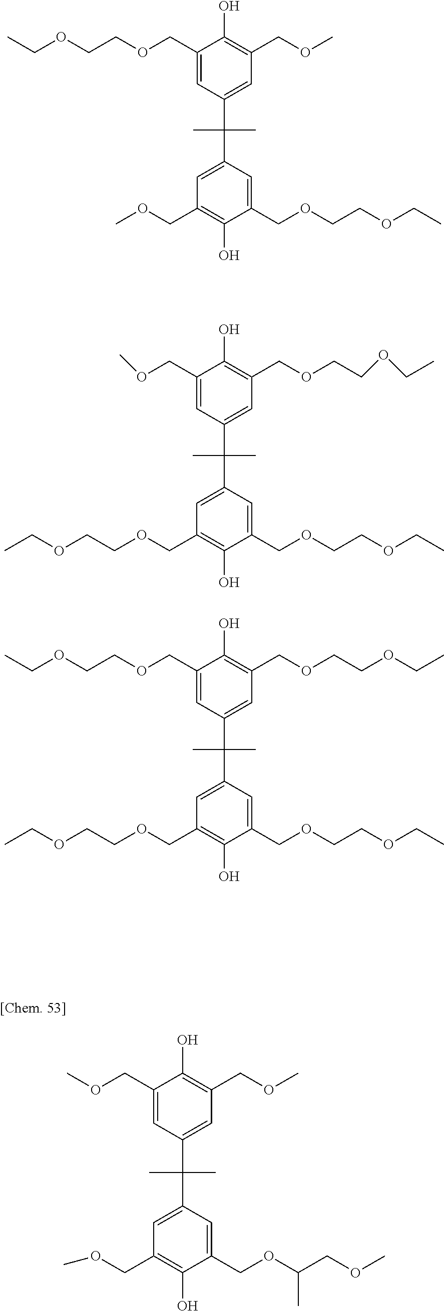

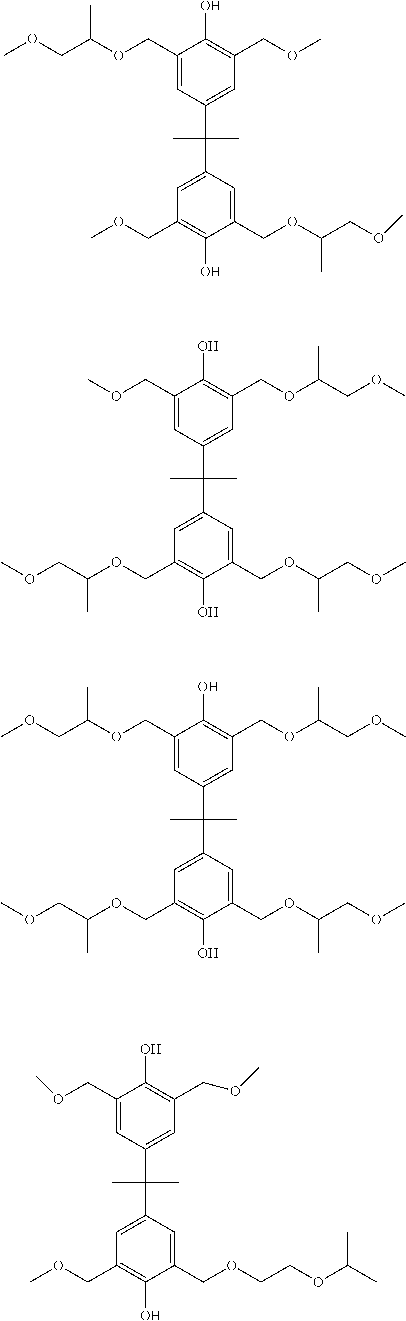

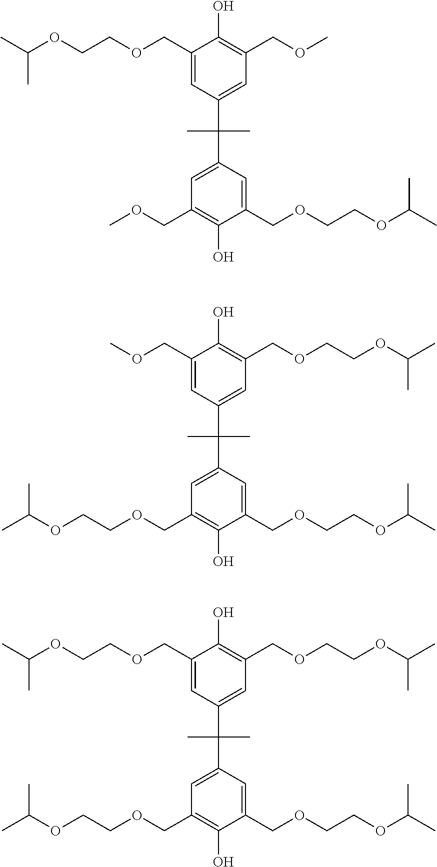

Examples of the compounds represented by Formulas (G-3) and (G-4) are shown below.

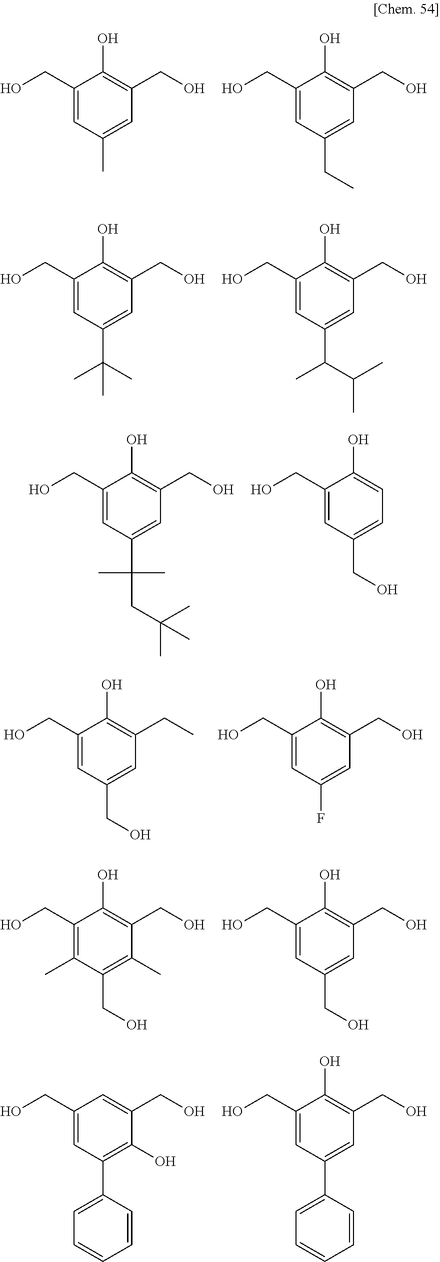

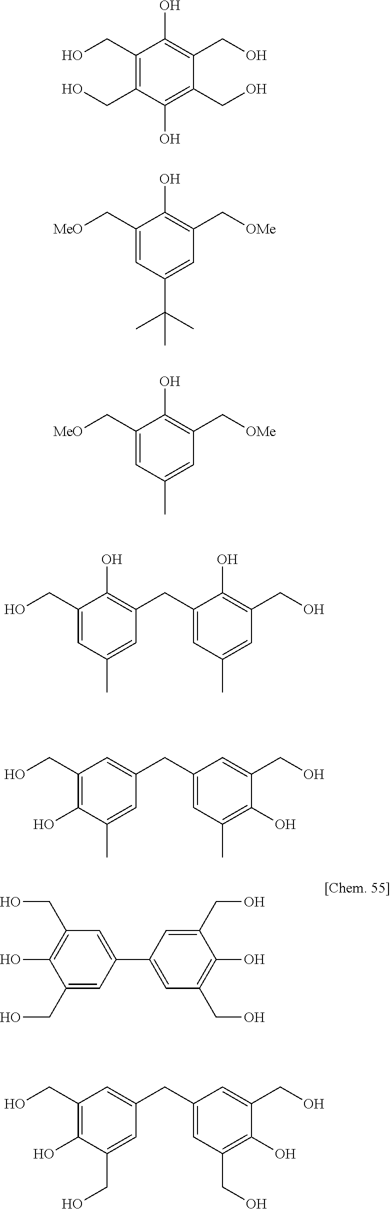

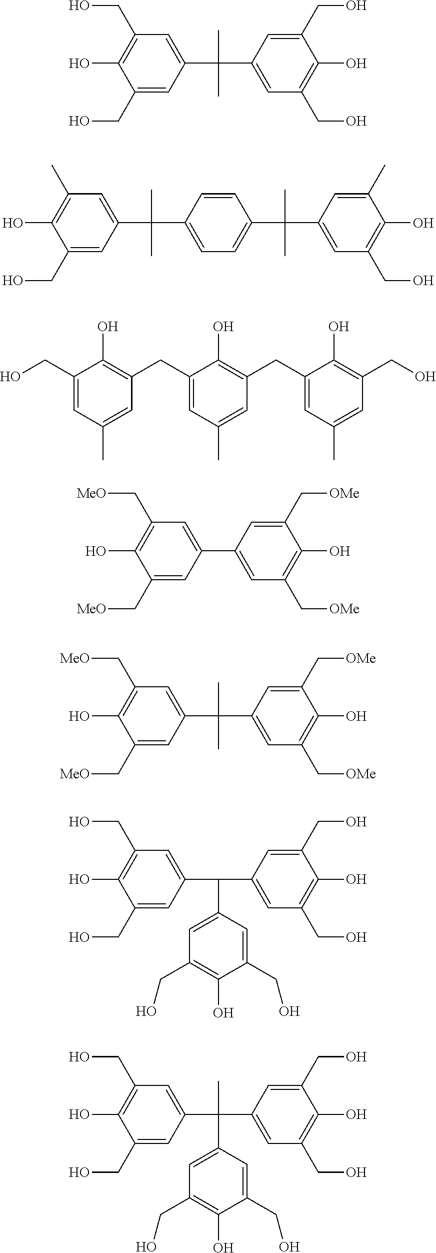

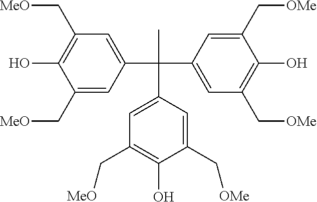

In the formula, Me represents a methyl group.

The entire disclosure of WO 2014/208542 A is incorporated herein.

In a case where the crosslinking agent is used, the content ratio of the crosslinking agent in the composition for forming a gap-filling material is not particularly limited, and is, for example, 1 mass % to 50 mass %, and preferably 5 mass % to 40 mass % relative to the specific compound and polymer.

### <Curing Catalyst>

As a curing catalyst contained as an optional component in the composition for forming a gap-filling material, any of a thermal acid generator and a photoacid generator can be used, and a thermal acid generator is preferably used.

Examples of the thermal acid generator include sulfonic acid compounds such as p-toluenesulfonic acid, trifluoromethanesulfonic acid, pyridinium-p-toluenesulfonate (pyridinium-p-toluenesulfonic acid), pyridinium phenolsulfonic acid, pyridinium-p-hydroxybenzenesulfonic acid (p-phenolsulfonic acid pyridinium salt), pyridinium-trifluoromethanesulfonic acid, salicylic acid, camphorsulfonic acid, 5-sulfosalicylic acid, 4-chlorobenzenesulfonic acid, 4-hydroxybenzenesulfonic acid, benzenedisulfonic acid, 1-naphthalenesulfonic acid, citric acid, benzoic acid, and hydroxybenzoic acid, and carboxylic acid compounds.

Examples of the photoacid generator include an onium salt compound, a sulfonimide compound, and a disulfonyl diazomethane compound.

Examples of the onium salt compound include iodonium salt compounds such as diphenyliodonium hexafluorophosphate, diphenyliodonium trifluoromethanesulfonate, diphenyliodonium nonafluoronormalbutanesulfonate, diphenyliodonium perfluoronormaloctanesulfonate, diphenyliodonium camphorsulfonate, bis(4-tert-butylphenyl)iodonium camphorsulfonate, and bis(4-tert-butylphenyl)iodonium trifluoromethanesulfonate, and sulfonium salt compounds such as triphenylsulfonium hexafluoroantimonate, triphenylsulfonium nonafluoronormalbutanesulfonate, triphenylsulfonium camphorsulfonate, and triphenylsulfonium trifluoromethanesulfonate.

Examples of the sulfonimide compound include N-(trifluoromethanesulfonyloxy)succinimide, N-(nonafluoronormalbutanesulfonyloxy)succinimide, N-(camphorsulfonyloxy)succinimide, and N-(trifluoromethanesulfonyloxy) naphthalimide.

Examples of the disulfonyl diazomethane compound include bis(trifluoromethylsulfonyl)diazomethane, bis(cyclohexylsulfonyl)diazomethane, bis(phenylsulfonyl)diazomethane, bis(p-toluenesulfonyl)diazomethane, bis(2,4-dimethylbenzenesulfonyl)diazomethane, and methylsulfonyl-p-toluenesulfonyl diazomethane.

Only one curing catalyst can be used, or two or more curing catalysts can be used in combination.

In a case where the curing catalyst is used, the content ratio of the curing catalyst is, for example, 0.1 mass % to 50 mass %, and preferably 1 mass % to 30 mass % relative to the crosslinking agent.

### <Solvent>

The composition for forming a gap-filling material contains a solvent.

As the solvent, an organic solvent which is generally used for a chemical solution for a semiconductor lithography process is preferable. Specific examples thereof include ethylene glycol monomethyl ether, ethylene glycol monoethyl ether, methyl cellosolve acetate, ethyl cellosolve acetate, diethylene glycol monomethyl ether, diethylene glycol monoethyl ether, propylene glycol, propylene glycol monomethyl ether, propylene glycol monoethyl ether, propylene glycol monomethyl ether acetate, propylene glycol propyl ether acetate, toluene, xylene, methyl ethyl ketone, methyl isobutyl ketone, cyclopentanone, cyclohexanone, cycloheptanone, 4-methyl-2 pentanol, methyl 2-hydroxyisobutyrate, ethyl 2-hydroxyisobutyrate, ethyl ethoxyacetate, 2-hydroxyethyl acetate, methyl 3-methoxypropionate, ethyl 3-methoxypropionate, ethyl 3-ethoxypropionate, methyl 3-ethoxypropionate, methyl pyruvate, ethyl pyruvate, ethyl acetate, butyl acetate, ethyl lactate, butyl lactate, 2-heptanone, methoxycyclopentane, anisole, y-butyrolactone, N-methylpyrrolidone, N, N-dimethylformamide, and N, N-dimethylacetamide. These solvents can be used alone or in combination of two or more thereof.

Among these solvents, propylene glycol monomethyl ether, propylene glycol monomethyl ether acetate, ethyl lactate, butyl lactate, and cyclohexanone are preferable. In particular, propylene glycol monomethyl ether and propylene glycol monomethyl ether acetate are preferable.

### <Other Components>

To the composition for forming a gap-filling material, a surfactant can be further added in order to further improve the application property for surface unevenness without the occurrence of pinholes, striations, and the like.

Examples of the surfactant include nonionic surfactants such as polyoxyethylene alkyl ethers such as polyoxyethylene lauryl ether, polyoxyethylene stearyl ether, polyoxyethylene cetyl ether, and polyoxyethylene oleyl ether, polyoxyethylene alkyl allyl ethers such as polyoxyethylene octylphenol ether and polyoxyethylene nonylphenol ether, polyoxyethylene/polyoxypropylene block copolymers, sorbitan fatty acid esters such as sorbitan monolaurate, sorbitan monopalmitate, sorbitan monostearate, sorbitan monooleate, sorbitan trioleate, and sorbitan tristearate, and polyoxyethylene sorbitan fatty acid esters such as polyoxyethylene sorbitan monolaurate, polyoxyethylene sorbitan monopalmitate, polyoxyethylene sorbitan monostearate, polyoxyethylene sorbitan trioleate, and polyoxyethylene sorbitan tristearate, fluorine surfactants such as EFTOP EF301, EF303, and EF352 (manufactured by Tohkem Products Corporation, trade name), MEGAFACE F171, F173, and R-30 (manufactured by DIC Corporation, trade name), FLUORAD FC430 and FC431 (manufactured by Sumitomo 3M Ltd., trade name), and ASAHIGUARD AG710, SURFLON S-382, SC101, SC102, SC103, SC104, SC105, and SC106 (manufactured by Asahi Glass Co., Ltd., trade name), and organosiloxane polymer KP341 (manufactured by Shin-Etsu Chemical Co., Ltd.).

The amount of these surfactants blended is not particularly limited, and is usually 2.0 mass % or less, and preferably 1.0 mass % or less relative to the total solid content of the composition for forming a gap-filling material.

These surfactants may be added alone or in combination of two or more thereof.

The film constituent components contained in the composition for forming a gap-filling material, that is, the components excluding the solvent are, for example, 0.01 mass % to 30 mass % of the composition for forming a gap-filling material.

The composition for forming a gap-filling material of the present invention is produced, for example, by a method for mixing at least one of the specific compound and polymer, a solvent, and the like with a known method. In order to use the composition for forming a gap-filling material, the composition is required to be in a uniform solution state. The composition after production is preferably produced by filtration with a filter or the like in order to remove metal impurities, foreign substances, and the like present in the composition.

One of the measures for evaluating whether the composition for forming a gap-filling material is in a uniform solution state is to observe the passing property of a specific microfilter. Preferably, the composition for forming a gap-filling material according to the present invention passes through a microfilter having a pore diameter of 0.1 μm, 0.05 μm, 0.03 μm, 0.02 μm, or 0.01 μm, and exhibits a uniform solution state.

Examples of the material of the microfilter include fluorine-based resins such as polytetrafluoroethylene (PTFE) and tetrafluoroethylene-perfluoroalkyl vinyl ether copolymer (PFA), polyethylene (PE), ultra-high-molecular-weight polyethylene (UPE), polypropylene (PP), polysulfone (PSF), polyether sulfone (PES), and nylon, and the microfilter is preferably made of polytetrafluoroethylene (PTFE).

The composition for forming a gap-filling material of the present invention is suitably used for temporary embedding of a through hole in an insulating layer in the production of a rewiring layer.

The rewiring layer is a layer for performing electrical connection between a semiconductor chip and an external take-out electrode or electrical connection between two external take-out electrodes. The rewiring layer used in the present invention has, for example, a via and wiring.

The insulating layer in temporary embedding of a through hole preferably has a through hole and has no groove for forming wiring.

The material of the insulating layer is not particularly limited, and examples thereof include an inorganic insulating material and an organic insulating material.

Examples of the inorganic insulating material include silicon oxide, aluminum oxide, tantalum oxide, titanium oxide, yttrium oxide, lanthanum oxide, hafnium oxide, zirconium oxide, silicon nitride, aluminum nitride, and mixtures thereof.

Examples of the organic insulating material include polyimide, polyamide, polyacrylate, polyvinyl alcohol, novolak resin, liquid crystal polymer, polybenzoxazole, and polyester.

The thickness of the insulating layer is not particularly limited, and is preferably 0.1 μm to 30 μm, more preferably 0.5 μm to 25 μm, and particularly preferably 1 μm to 20 μm.

The area of the opening of the through hole is not particularly limited, and is preferably 0.1 μm to 30 μm, more preferably 0.2 μm to 25 μm, and particularly preferably 0.3 μm to 20 μm in terms of equivalent circle diameter. The equivalent circle diameter is a diameter of a circle having the same area as a target opening.

The aspect ratio of the through hole (thickness of insulating layer/circle equivalent diameter of opening of through hole) is not particularly limited, and is preferably 0.1 to 20, more preferably 0.2 to 15, and particularly preferably 0.3 to 10.

The thickness of the insulating layer and the area of the opening of the through hole can be obtained by, for example, scanning electron microscopic observation.

### (Cured Gap-Filling Material)

A cured gap-filling material of the present invention is formed by applying the composition for forming a gap-filling material of the present invention to a substrate and then baking the composition.

The substrate to which the composition for forming a gap-filling material is applied is not particularly limited, and examples thereof include a substrate having an insulating layer having a through hole formed therein.

The substrate may be an insulating layer itself having a through hole formed therein, or a substrate having an insulating layer and a further layer or base material below the insulating layer. Examples of the layer include a rewiring layer.

Examples of the material of the base material include metal and resin. Examples of the metal include copper. Examples of the resin include polyimide.

The method for applying the composition for forming a gap-filling material to the substrate is not particularly limited, and examples thereof include appropriate application methods such as a spinner and a coater. Thereafter, baking is performed using heating means such as a hot plate to form a cured gap-filling material. The baking conditions are appropriately selected from a baking temperature of 100° C. to 400° C. and a baking time of 0.3 minutes to 60 minutes. It is preferable that the baking temperature be 120° C. to 350° C., and the baking time be 0.5 minutes to 30 minutes, and it is more preferable that the baking temperature be 150° C. to 300° C., and the baking time be 0.8 minutes to 10 minutes.

The cured gap-filling material can be removed with, for example, a chemical solution. Examples of the chemical solution include an organic solvent. The chemical solution may include an acidic compound or a basic compound in addition to the organic solvent.

Examples of the organic solvent include dimethylsulfoxide, dimethylformamide, dimethylacetamide, N-methylpyrrolidone, N-ethylpyrrolidone, ethylene glycol, propylene glycol, and diethylene glycol dimethyl ether.

Examples of the acidic compound include an inorganic acid and an organic acid. Examples of the inorganic acid include hydrochloric acid, sulfuric acid, nitric acid, and phosphoric acid. Examples of the organic acid include p-toluenesulfonic acid, trifluoromethanesulfonic acid, salicylic acid, 5-sulfosalicylic acid, 4-phenolsulfonic acid, camphorsulfonic acid, 4-chlorobenzenesulfonic acid, benzenedisulfonic acid, 1-naphthalenesulfonic acid, acetic acid, propionic acid, trifluoroacetic acid, citric acid, benzoic acid, hydroxybenzoic acid, and naphthalenecarboxylic acid.

Examples of the basic compound include an inorganic base and an organic base. Examples of the inorganic base include alkali metal hydroxides such as sodium hydroxide and potassium hydroxide, quaternary ammonium hydroxides such as tetramethylammonium hydroxide, tetraethylammonium hydroxide, and choline, and amines such as ethanolamine, propylamine, diethylaminoethanol, and ethylenediamine.

As the organic solvent used for the chemical solution, only one organic solvent can be used, or two or more organic solvents can be used in combination.

In addition, as the acidic compound or basic compound used for the chemical solution, only one compound can be used, or two or more compounds can be used in combination.

The amount of the acidic compound or basic compound blended is, for example, 0.01 mass % to 20 mass %, preferably 0.1 mass % to 5 mass %, and particularly preferably 0.2 mass to 1 mass % relative to the chemical solution.

In addition, the chemical solution is preferably an organic solvent (basic organic solvent) containing a basic compound, and particularly preferably a mixed liquid containing dimethyl sulfoxide and tetramethylammonium hydroxide.

Examples of commercially available products of the basic organic solvent include ST-120 (Tokyo Ohka Kogyo Co., Ltd.).

### (Rewiring Layer Producing Method and Wiring Circuit Board Producing Method)

A rewiring layer producing method of the present invention includes a step of filling a through hole.

A wiring circuit board producing method of the present invention includes a step of producing a rewiring layer. The step of producing a rewiring layer is the rewiring layer producing method of the present invention.

The step of filling a through hole is a step of filling a through hole of the insulating layer with the cured gap-filling material formed from the composition for forming a gap-filling material of the present invention.

An embodiment of the rewiring layer producing method and an embodiment of the wiring circuit board producing method will be described with reference to the drawings.

FIGS. 2A to 2K are schematic diagrams for explaining the formation of a rewiring layer using a dual damascene process.

First, a stacked body having a support 1 and an insulating layer 2 provided on the support 1 is prepared (FIG. 2A). A through hole is formed in the insulating layer 2. The insulating layer 2 used here is, for example, a non-photosensitive insulating layer. Examples of the material of the insulating layer include polyimide, polybenzoxazole, liquid crystal polymer, and silicon oxide.

The through hole is formed by, for example, photolithography. For example, the through hole can be formed by forming a photoresist pattern on the insulating layer and etching the insulating layer using the pattern as a mask.

The thickness of the insulating layer is not particularly limited, and is preferably 0.1 μm to 30 μm, more preferably 0.5 μm to 25 μm, and particularly preferably 1 μm to 20 μm.

The area of the opening of the through hole is not particularly limited, and is preferably 0.1 μm to 30 μm, more preferably 0.2 μm to 25 μm, and particularly preferably 0.3 μm to 20 μm in terms of equivalent circle diameter.

The aspect ratio of the through hole (thickness of insulating layer/circle equivalent diameter of opening of through hole) is not particularly limited, and is preferably 0.1 to 20, more preferably 0.2 to 25, and particularly preferably 0.3 to 10.

The support 1 is not particularly limited as long as it can support the insulating layer 2, and examples thereof include a base material and a rewiring layer.

Examples of the material of the base material include metal and resin. Examples of the metal include copper. Examples of the resin include polyimide.

Next, the composition for forming a gap-filling material of the present invention is applied to the insulating layer 2 and baked to form a cured gap-filling material 3 (FIG. 2B). Since the composition for forming a gap-filling material enters the through hole, the cured gap-filling material 3 formed fills the through hole.

The application method is not particularly limited, and examples thereof include the application methods mentioned in the description of the cured gap-filling material of the present invention.

The baking conditions are not particularly limited, and examples thereof include the baking conditions mentioned in the description of the cured gap-filling material of the present invention.

Next, unnecessary parts of the cured gap-filling material 3 on the insulating layer 2 are removed (FIG. 2C). Specifically, in the cured gap-filling material 3 on the insulating layer 2, a cured gap-filling material 3 excluding a cured gap-filling material 3 filling the through hole is removed. The unnecessary cured gap-filling material 3 is removed by, for example, wet etching using a basic organic solvent or dry etching.

Next, a photoresist layer 4 for processing the insulating layer 2 into a desired shape is formed on the insulating layer 2 in which the through hole is filled with the cured gap-filling material 3 (FIG. 2D). The photoresist used for the photoresist layer 4 is not particularly limited as long as it is a photoresist which can be removed after the insulating layer 3 is processed into a desired shape. Examples thereof include a photoresist for i-rays, a photoresist for KrF excimer laser, and a photoresist for ArF excimer laser, which are used for fine processing. The photoresist may be a positive photoresist or a negative photoresist. The thickness of the photoresist layer 4 is not particularly limited, and is, for example, 0.5 μm to 3 μm.

Next, the photoresist layer 4 is processed into a predetermined pattern by photolithography using exposure and development (FIG. 2E). In this case, since the cured gap-filling material 3 filling the through hole has an antireflection function, it is possible to prevent patterning failure of the photoresist layer 4 which is in contact with the cured gap-filling material 3.

Next, using the patterned photoresist layer 4 as a mask, a groove (groove 5b for forming wiring) for forming wiring is formed in the insulating layer 2 by etching. In that case, the cured gap-filling material 3 filling the through hole is also removed, and a through hole (through hole 5a for forming a via) for forming a via is formed (FIG. 2F). Examples of the etching for forming the groove 5b for forming wiring include dry etching. In addition, examples of the method for removing the cured gap-filling material 3 filling the through hole include wet etching using a basic organic solvent. A part or the whole of the cured gap-filling material 3 filling the through hole may be removed from the through hole by etching for forming the groove 5b for forming wiring.

The thickness of the groove for forming wiring is not particularly limited, and is, for example, preferably 0.05 μm to 30 μm, more preferably 0.1 μm to 20 μm, and particularly preferably 0.2 μm to 10 μm. The width of the groove for forming wiring is, in other words, the length in a lateral direction of the groove for forming wiring in a direction orthogonal to the thickness direction of the insulating layer.

The depth of the groove for forming wiring is not particularly limited, and is, for example, preferably 0.05 μm to 5 μm, more preferably 0.1 μm to 4 μm, and particularly preferably 0.2 μm to 3 μm. The depth of the groove for forming wiring is, in other words, the length of the groove for forming wiring in the thickness direction of the insulating layer.

The depth of the groove for forming wiring is not particularly limited, and may be, for example, 1/50 or more, 1/30 or more, or 1/20 or more of the thickness of the insulating layer. In addition, the depth of the groove for forming wiring may be less than 1/1, ½ or less, or 1/10 or less of the thickness of the insulating layer.

The width of the groove for forming wiring corresponds to the wiring width of the wiring to be described later.

The depth of the groove for forming wiring corresponds to the wiring height of the wiring to be described later.

Next, a barrier-seed layer 6 serving as both a barrier layer and a seed layer is formed on a surface of the insulating layer 2 in which the through hole 5a for forming a via and the groove 5b for forming wiring are formed (FIG. 2G). The barrier-seed layer 6 has, for example, a two-layer structure of a Ti layer as a lower layer and a Cu layer as an upper layer. The barrier-seed layer 6 is also formed on the surface of the insulating layer 2 in the through hole 5a for forming a via and the groove 5b for forming wiring.

Next, a plating layer 7 is formed on the barrier-seed layer 6 (FIG. 2H). The plating layer 7 is, for example, a Cu layer. The plating layer 7 is formed so that the plating layer 7 fills the through hole 5a for forming a via and the groove 5b for forming wiring. The plating layer 7 is formed by, for example, electrolytic plating. The plating layer 7 may be formed by electroless plating. In that case, since the formation of a seed layer is not necessary, a barrier layer is formed instead of the barrier-seed layer 6.

Next, the plating layer 7 and the barrier-seed layer 6 on the upper surface of the insulating layer 2 are removed (FIG. 2I). The plating layer 7 and the barrier-seed layer 6 on the upper surface of the insulating layer 2 are removed by, for example, chemical mechanical polishing (CMP). As a result, the plating materials filling the through hole 5a for forming a via and the groove 5b for forming wiring are electrically independent, and a via 7a and wiring 7b are formed (FIG. 2I).

Through the above process, as shown in FIG. 2I, a rewiring layer having the insulating layer 2, the via 7a formed inside the insulating layer 2, and the wiring 7b formed inside the insulating layer 2 is obtained.

In the rewiring layer, the barrier layer is formed not only on the bottom surfaces but also on the side surfaces of the via 7a and the wiring 7b, and thus it is possible to further prevent the metal constituting the via and the wiring from migrating to the insulating layer compared to a case where the barrier layer is formed only on the bottom surfaces of the via and the wiring.

In addition, in the rewiring layer, the wiring 7b is formed inside the insulating layer 2 and does not protrude from the surface of the insulating layer 2. In other words, in the rewiring layer, the via and the wiring via are exposed on the surface of the insulating layer, and on the surface, the exposed surface of the via, the exposed surface of the wiring, and the surface of the insulating layer form a flat surface. Therefore, the rewiring layer has a uniform thickness. When the rewiring layer having a uniform thickness is stacked to obtain a stacked body, a stacked body having excellent flatness can be obtained.

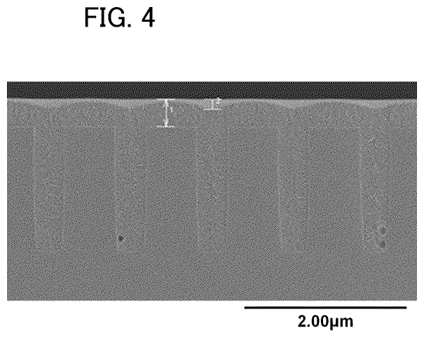

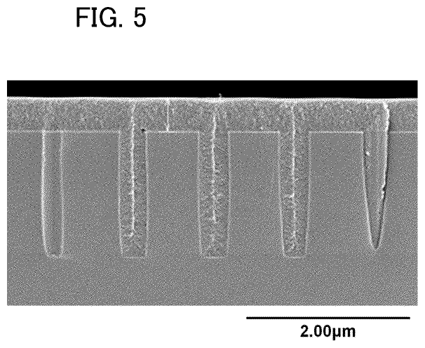

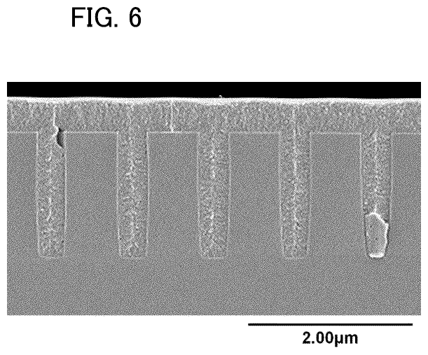

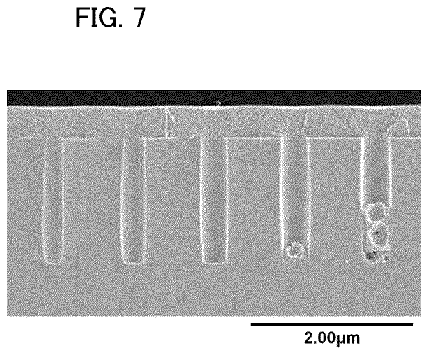

Furthermore, an insulating layer 8 is formed on the insulating layer 2 in which the via 7a and the wiring 7b are formed (FIG. 2J). The insulating layer 8 is, for example, a non-photosensitive insulating layer. Next, a through hole is formed in the insulating layer 8 (FIG. 2K). Next, the same steps as those shown in FIGS. 2B to 21 are performed. As a result, it is possible to create a multilayer structure of the rewiring layers.

### EXAMPLES

Hereinafter, the present invention will be described in greater detail with reference to Synthesis Examples and Examples. However, the present invention is not limited to the following examples.

A device and the like used for the measurement of weight average molecular weights of polymers obtained in the following Synthesis Examples are shown.
Device: HLC-8320GPC manufactured by Tosoh Corporation
GPC column: Shodex [registered trade name]. Asahipak [registered trade name] (Showa Denko K. K.)
Column temperature: 40° C.
Flow rate: 0.35 mL/min
Eluent: tetrahydrofuran (THE)
Standard sample: polystyrene (Tosoh Corporation)

### Synthesis Example 1

9.00 g of a triazine type epoxy compound (product name: TEPIC, manufactured by Nissan Chemical Corporation, epoxy functionality: 10.03 eq./kg), 5.51 g of 4-hydroxybenzaldehyde, 6.78 g of a terephthalaldehydic acid, 1.53 g of tetrabutylphosphonium bromide, and 34.23 g of propylene glycol monomethyl ether were added to a reaction flask, and heated and refluxed for 23 hours under a nitrogen atmosphere. Subsequently, a solution obtained by dissolving 5.96 g of malononitrile in 32.93 g of propylene glycol monomethyl ether was added to the system, and further heated and refluxed for 4 hours. The obtained reaction product corresponded to Formula (A-1), and a weight average molecular weight Mw thereof measured in terms of polystyrene by GPC was 900.

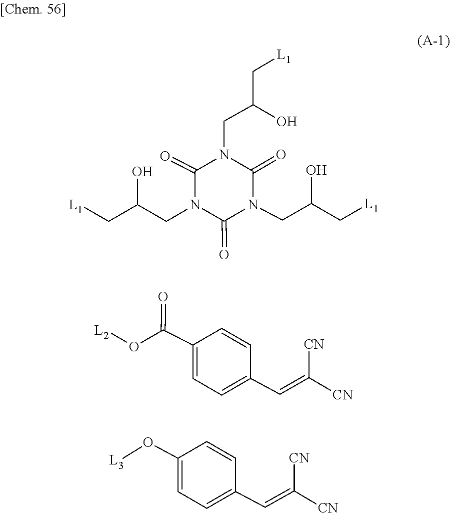

(L₁, L₂, and L₃ each represent a bond, and L₁ combines with L₂ or L₃ to form a single bond.)

### Synthesis Example 2

5.00 g of a triazine type epoxy compound (product name: TEPIC, manufactured by Nissan Chemical Corporation, epoxy functionality: 10.03 eq./kg), 4.26 g of 4-hydroxybenzaldehyde, 2.71 g of thioglycerol, 0.51 g of tetrabutylphosphonium bromide, and 49.92 g of propylene glycol monomethyl ether were added to a reaction flask, and heated and refluxed for 6 hours under a nitrogen atmosphere. Subsequently, a solution obtained by dissolving 1.56 g of malononitrile in 4.0 g of propylene glycol monomethyl ether was added to the system, and further heated and refluxed for 4 hours. The obtained reaction product corresponded to Formula (A-2), and a weight average molecular weight Mw thereof measured in terms of polystyrene by GPC was 1, 300.

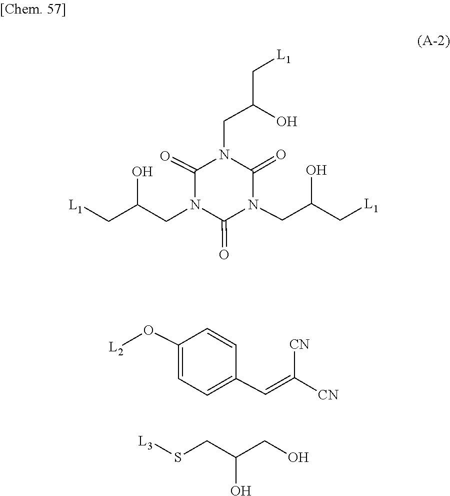

(L₁, L₂, and L₃ each represent a bond, and L₁ combines with Ly or L₃ to form a single bond.)

### Synthesis Example 3

10.00 g of a terephthalic acid diglycidyl ester (product name: EX-711, manufactured by Nagase ChemteX Corporation), 6.86 g of an x-cyano-4-hydroxycinnamic acid, 0.59 g of tetrabutylphosphonium bromide, and 69.80 g of propylene glycol monomethyl ether were added to a reaction flask, and heated and stirred at an internal temperature of 105° C. for 24 hours under a nitrogen atmosphere. The obtained reaction product corresponded to Formula (A-3), and a weight average molecular weight Mw thereof measured in terms of polystyrene by GPC was 1, 930.

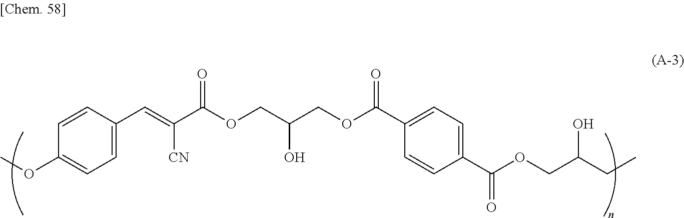

### Synthesis Example 4

10.00 g of monoallyl diglycidyl isocyanurate (product name: MA-DGIC, manufactured by Shikoku Chemicals Corporation), 7.12 g of an x-cyano-4-hydroxycinnamic acid, 0.61 g of tetrabutylphosphonium bromide, and 70.89 g of propylene glycol monomethyl ether were added to a reaction flask, and heated and stirred at an internal temperature of 105° C. for 24 hours under a nitrogen atmosphere. The obtained reaction product corresponded to Formula (A-4), and a weight average molecular weight Mw thereof measured in terms of polystyrene by GPC was 2, 671.

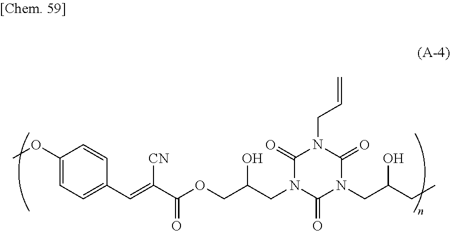

### Comparative Synthesis Example 1

15.00 g of a phenol novolak type epoxy resin (product name: DEN, manufactured by The Dow Chemical Company, epoxy functionality: 5.55 eq./kg), 10.17 g of 4-hydroxybenzaldehyde, 1.41 g of tetrabutylphosphonium bromide, and 39.87 g of propylene glycol monomethyl ether were added to a reaction flask, and heated and refluxed for 24 hours under a nitrogen atmosphere. Subsequently, a solution obtained by dissolving 5.50 g of malononitrile in 34.99 g of propylene glycol monomethyl ether was added to the system, and further heated and refluxed for 4 hours. The obtained reaction product corresponded to Formula (A-5), and a weight average molecular weight Mw thereof measured in terms of polystyrene by GPC was 2,100.

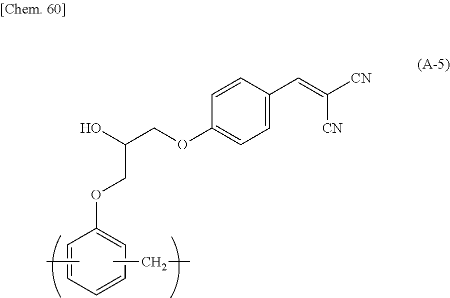

### Example 1

To 3.65 g of the solution of the reaction product corresponding to Formula (A-1) (of which the solid content was 16.9 mass %), 0.12 g of tetramethoxymethyl glycoluril as a crosslinking agent, 0.006 g of pyridinium-p-toluenesulfonate as a crosslinking catalyst, 1.16 g of propylene glycol monomethyl ether, and 1.05 g of propylene glycol monomethyl ether acetate were added to prepare a composition for forming a gap-filling material.

### Example 2

To 3.75 g of the solution of the reaction product corresponding to Formula (A-2) (of which the solid content was 16.5 mass %), 0.12 g of tetramethoxymethyl glycoluril as a crosslinking agent, 0.006 g of pyridinium-p-toluenesulfonate as a crosslinking catalyst, 1.16 g of propylene glycol monomethyl ether, and 1.05 g of propylene glycol monomethyl ether acetate were added to prepare a composition for forming a gap-filling material.

### Example 3

To 3.22 g of the solution of the reaction product corresponding to Formula (A-3) (of which the solid content was 19.2 mass %), 0.12 g of tetramethoxymethyl glycoluril as a crosslinking agent, 0.006 g of pyridinium-p-toluenesulfonate as a crosslinking catalyst, 1.60 g of propylene glycol monomethyl ether, and 1.05 g of propylene glycol monomethyl ether acetate were added to prepare a composition for forming a gap-filling material.

### Example 4

To 3.24 g of the solution of the reaction product corresponding to Formula (A-4) (of which the solid content was 19.1 mass %), 0.12 g of tetramethoxymethyl glycoluril as a crosslinking agent, 0.006 g of pyridinium-p-toluenesulfonate as a crosslinking catalyst, 1.58 g of propylene glycol monomethyl ether, and 1.05 g of propylene glycol monomethyl ether acetate were added to prepare a composition for forming a gap-filling material.

### Comparative Example 1

To 2.62 g of the solution of the reaction product corresponding to Formula (A-5) (of which the solid content was 28.8 mass %), 0.47 g of hexamethoxymethylmelamine as a crosslinking agent, 0.02 g of a p-toluenesulfonic acid as a crosslinking catalyst, 6.01 g of propylene glycol monomethyl ether, and 0.88 g of ethyl lactate were added to prepare a composition for forming a gap-filling material.

### [Evaluation of Optical Constant]

The composition for forming a gap-filling material prepared in each of Examples 1 to 4 and Comparative Example 1 was applied to a silicon wafer by a spin coater so that a film thickness of a film to be obtained was about 50 nm, and the film was baked on a hot plate at 200° C. for 90 seconds. An n-value (refractive index) and a k-value (attenuation coefficient) of the obtained film were measured at 365 nm (i-ray wavelength) using a spectroscopic ellipsometer (VUV-VASE, manufactured by J.A. Woolam). The results are shown in Table 1.

TABLE 1

| | n/k (365 nm) |
|---|---|
| Example 1 | 1.83/0.23 |
| Example 2 | 1.75/0.24 |
| Example 3 | 1.78/0.21 |
| Example 4 | 1.79/0.20 |
| Comparative Example 1 | 1.83/0.35 |

In Examples 1 to 4 and Comparative Example 1, an appropriate n value and an appropriate k value are obtained at 365 nm. In a lithography process using radiation such as i-rays, an antireflection function is exhibited which can suppress reflections (standing waves) from the underlying substrate, which becomes a factor of an unfavorable resist pattern.

### [Test of Resistance to Resist Solvent]

For evaluation of resistance to a resist solvent (organic solvent), the composition for forming a gap-filling material prepared in each of Examples 1 to 4 and Comparative Example 1 was applied to a silicon wafer, and heated at 150° C. for 180 seconds to form a film. Next, the film was immersed in OK73 thinner (product manufactured by Tokyo Ohka Kogyo Co., Ltd.) at room temperature for 1 minute, and the removability of the film after immersion was observed. The results are shown in Table 2. In a case where the film was removed (the film was peeled off), the film was determined to have no resistance to the resist solvent (organic solvent), and in a case where the film was not removed (the film was not peeled off), the film was determined to have resistance.

TABLE 2

| | Removability of Coating Film |
|---|---|
| | by OK73 Thinner |
| Example 1 | No peeling |
| Example 2 | No peeling |
| Example 3 | No peeling |
| Example 4 | No peeling |
| Comparative Example 1 | No peeling |

As seen from the above results, the compositions for forming a gap-filling material of Examples 1 to 4 and

Comparative Example 1 were not removed (peeled off) by the OK73 thinner, and thus it can be said that they have good chemical resistance to the organic solvent (resist solvent).

### [Test of Removability by Wet Etching Chemical Solution]

For evaluation of removability by a wet etching chemical solution (basic organic solvent), the composition for forming a gap-filling material prepared in each of Examples 1 to 4 and Comparative Example 1 was applied to a copper substrate, and heated at 150° C. for 180 seconds to form a film having a thickness of 100 nm. Next, the copper substrate having the film formed thereon was immersed in a basic organic solvent ST-120 (manufactured by Tokyo Ohka Kogyo Co., Ltd.) at 70° C. for 10 minutes, and the removability of the film after immersion was visually observed. The results are shown in Table 3. In a case where the film was removed (the film was peeled off), the film was determined to be good in removability (peelability) by the basic organic solvent, and in a case where the film was not removed (the film was not peeled off), the film was determined to have no good removability (peelability).

TABLE 3

| | Removability of Coating Film |
|---|---|
| | by Wet Etching Chemical |
| | Solution (ST-120) |
| Example 1 | Whole peeled |
| Example 2 | Whole peeled |
| Example 3 | Whole peeled |
| Example 4 | Whole peeled |
| Comparative Example 1 | No Peeling |

As seen from the above results, in cases of the compositions for forming a gap-filling material of Examples 1 to 4, the film on the copper substrate was sufficient in removability by the wet etching chemical solution (basic organic solvent) compared to the film of the composition for forming a gap-filling material of Comparative Example 1. That is, since the film obtained from the composition for forming a gap-filling material of Example 1 can exhibit good removability (peelability) with respect to the wet etching chemical solution, the composition is useful in a semiconductor producing process in which a film is removed with a wet etching chemical solution.

### [Embeddability and Flatness in Step Substrate]

For evaluation of embeddability and flatness in a step substrate, the composition for forming a gap-filling material prepared in each of Examples 1 to 4 and

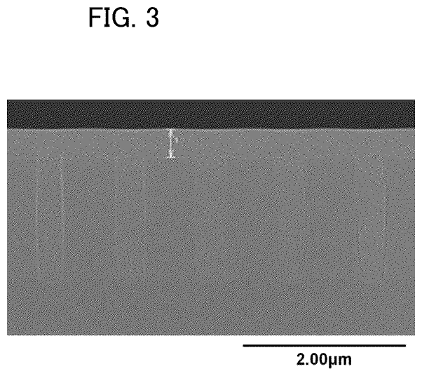

Comparative Example 1 was applied to a hole substrate having a hole having a depth of 1.6 μm and a diameter of 0.36 μm, and heated at 200° C. for 180 seconds to form a film. Thereafter, embeddability and flatness in the hole substrate were observed with a cross-sectional SEM. The results are shown in FIGS. 3 to 7.

As seen from the observation results of the cross-sectional SEMs, the compositions for forming a gap-filling material of Examples 1 to 4 were good in embeddability and flatness in the hole substrate, and no voids were observed inside the hole. However, in Comparative Example 1, a gap was formed at the interface between the hole substrate and the film, and the film peeled off when the substrate was cut and observed by SEM, so that the film inside the hole could not be observed. That is, since the films obtained from the compositions for forming a gap-filling material of Examples 1 to 4 can exhibit good embeddability in the hole substrate, the compositions are useful in a semiconductor producing process in which a step substrate is made flat.

### REFERENCE SIGNS LIST

1 Support
2 Insulating layer
3 Cured gap-filling material
4 Photoresist layer
5a Through hole for forming via
5b Groove for forming wiring
6 Barrier-seed layer
7 Plating layer
7a Via
7b Wiring
8 Insulating layer
101 Substrate
102 Photosensitive resin layer
103 Barrier-seed layer
104 Plating resist
105 Plating layer
105a Via
105b Wiring
106 Photosensitive resin layer

1. A composition for forming a gap-filling material,
comprising: at least one of a compound and a polymer having a structure represented by the following Formula (1) and a carbonyl bond; and a solvent, 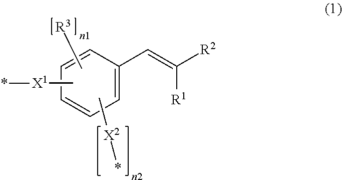
in Formula (1), R¹ and R² each independently represent a hydrogen atom, a cyano group, a phenyl group, an alkyl group having 1 to 13 carbon atoms, a halogen atom, —COOR¹¹ (R¹¹ represents a hydrogen atom or an alkyl group having 1 to 4 carbon atoms), or —COO—,
R³ represents a methoxy group, an alkyl group having 1 to 13 carbon atoms, or a halogen atom, and when two or more R³'s are present, the two or more R³'s may be the same or different,
n1 represents an integer of 0 to 4, and n2 represents an integer of 0 or 1, provided that the sum of n1 and n2 is 4 or less,
X¹ represents an ether bond or an ester bond,
X² represents an ether bond or an ester bond, and
* represents a bond.

2. The composition for forming a gap-filling material according to claim 1, wherein the compound and the polymer have, as a structure having the carbonyl bond, at least one of a structure represented by the following Formula (2) and a structure represented by the following Formula (3), 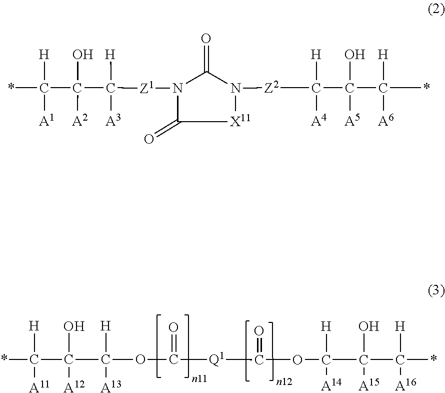
in Formula (2), X¹¹ represents a group represented by any one of the following Formulas (2-1) to (2-4), Z¹ and Z² each independently represent a single bond or a divalent group represented by the following Formula (2-5) (in Formula (2-5), *3 represents a bond bonded to a nitrogen atom in Formula (2)), A¹, A², A³, A⁴, A⁵, and A⁶ each independently represent a hydrogen atom, a methyl group, or an ethyl group, and * represents a bond, and
in Formula (3), Q¹ represents a divalent organic group having an aromatic hydrocarbon ring, A¹¹, A¹², A¹³, A¹⁴, A¹⁵, and A¹⁶ each independently represent a hydrogen atom, a methyl group, or an ethyl group, n11 and n12 represent an integer of 0 or 1, provided that at least one of n11 and n12 is 1, and * represents a bond, 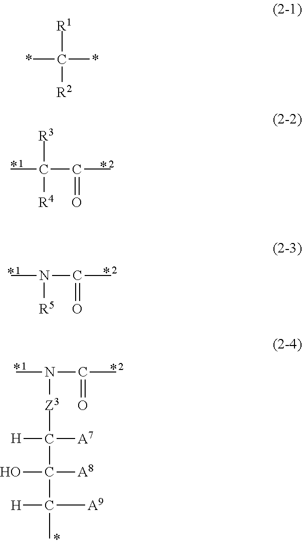
in Formulas (2-1) to (2-3), R¹ to R⁵ each independently represent a hydrogen atom, an alkyl group having 1 to 10 carbon atoms which may be interrupted with an oxygen atom or a sulfur atom, an alkenyl group having 2 to 10 carbon atoms which may be interrupted with an oxygen atom or a sulfur atom, an alkynyl group having 2 to 10 carbon atoms which may be interrupted with an oxygen atom or a sulfur atom, a benzyl group, or a phenyl group, the phenyl group may be substituted with at least one monovalent group selected from the group consisting of an alkyl group having 1 to 6 carbon atoms, a halogen atom, an alkoxy group having 1 to 6 carbon atoms, a nitro group, a cyano group, and an alkylthio group having 1 to 6 carbon atoms, R¹ and R² may be bonded to each other to form a ring having 3 to 6 carbon atoms, and R³ and R⁴ may be bonded to each other to form a ring having 3 to 6 carbon atoms,
in Formula (2-4), Z³ represents a single bond or a divalent group represented by the following Formula (2-5) (in Formula (2-5), *3 represents a bond bonded to a nitrogen atom in Formula (2-4)), and A⁷, A⁸, and A⁹ each independently represent a hydrogen atom, a methyl group, or an ethyl group, and
* represents a bond, *1 represents a bond bonded to a carbon atom in Formula (2), and *2 represents a bond bonded to a nitrogen atom in Formula (2), 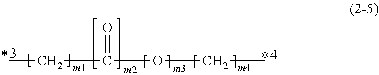
in Formula (2-5), m1 is an integer of 0 to 4, m2 is 0 or 1, m3 is 0 or 1, m4 is an integer of 0 to 2, provided that, when m3 is 1, m1 and m2 are not both 0 at the same time, *3 represents a bond bonded to a nitrogen atom in Formula (2) or (2-4), and *4 represents a bond bonded to a carbon atom in Formula (2) or (2-4).

3. The composition for forming a gap-filling material according to claim 2, wherein Q¹ is represented by the following Formula (3-1) or (3-2), 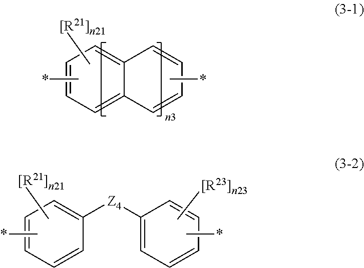
in Formulas (3-1) and (3-2), R²¹ to R²³ each independently represent a halogen atom, a hydroxy group, an alkyl group having 1 to 6 carbon atoms, an alkenyl group having 2 to 6 carbon atoms, an alkynyl group having 2 to 6 carbon atoms, an alkoxy group having 1 to 6 carbon atoms, an alkenyloxy group having 2 to 6 carbon atoms, an alkynyloxy group having 2 to 6 carbon atoms, an acyl group having 2 to 6 carbon atoms, an aryloxy group having 6 to 12 carbon atoms, an arylcarbonyl group having 7 to 13 carbon atoms, or an aralkyl group having 7 to 13 carbon atoms, and * represents a bond,
in Formula (3-1), n3 represents 0 or 1, when n3 is 0, n21 represents an integer of 0 to 4, when n3 is 1, n21 represents an integer of 0 to 6, and when two or more R²¹'s are present, the two or more R²¹'s may be the same or different, and
in Formula (3-2), Z⁴ represents a single bond, an oxygen atom, a sulfur atom, a carbonyl group, a sulfonyl group, or an alkylene group having 1 to 6 carbon atoms, n22 and n23 each independently represent an integer of 0 to 4, when two or more R²²'s are present, the two or more R²²'s may be the same or different, and when two or more R²⁵'s are present, the two or more R²³'s may be the same or different.

4. The composition for forming a gap-filling material according to claim 1, wherein R¹ represents a cyano group or —COOR¹¹ (R¹¹ represents a hydrogen atom or an alkyl group having 1 to 4 carbon atoms).

5. The composition for forming a gap-filling material according to claim 1, wherein R² represents a cyano group, —COOR¹¹ (R¹¹ represents a hydrogen atom or an alkyl group having 1 to 4 carbon atoms), or —COO—.

6. The composition for forming a gap-filling material according to claim 1, wherein X¹ represents an ether bond.

7. The composition for forming a gap-filling material according to claim 1, wherein n2 represents 0.

8. The composition for forming a gap-filling material according to claim 1, wherein a crosslinking agent is contained.

9. The composition for forming a gap-filling material according to claim 1, which is used for temporary embedding of a through hole in an insulating layer in production of a rewiring layer.

10. A cured gap-filling material, which is formed by applying the composition for forming a gap-filling material according to claim 1 to a substrate and then baking the composition.

11. The cured material according to claim 10, which is removable with a chemical solution.

12. A rewiring layer producing method comprising a step of: filling a through hole of an insulating layer with a cured gap-filling material formed from the composition for forming a gap-filling material according to claim 1.

13. The rewiring layer producing method according to claim 12, further comprising a step of: removing the cured gap-filling material with a chemical solution after the step of filling the through hole.

14. A wiring circuit board producing method comprising a step of: producing a rewiring layer,
wherein the step of producing a rewiring layer includes a step of filling a through hole of an insulating layer with a cured gap-filling material formed from the composition for forming a gap-filling material according to claim 1.

15. The wiring circuit board producing method according to claim 14, further comprising a step of: removing the cured gap-filling material with a chemical solution after the step of filling the through hole.
